(19) United States
(12) Patent Application Publication
(10) Pub. No.: US 2026/0253407 A1
(43) Pub. Date: Aug. 27, 2026

(54) PRIORITY-BASED RETENTION OF VISION ENCODER OUTPUT

(71) Applicant: QUALCOMM Incorporated, San Diego, CA (US)

(72) Inventors: Munawar HAYAT, San Diego, CA (US); Titash RAKSHIT, Austin, TX (US)

(21) Appl. No.: 19/543,597

(22) Filed: Feb. 18, 2026

Related U.S. Application Data
(60) Provisional application No. 63/764,255, filed on Feb. 27, 2025.

(51) Int. Cl. G06V 10/94; G06F 40/284; G06V 10/82

(52) U.S. Cl. CPC G06V 10/945; G06F 40/284; G06V 10/82

(57) ABSTRACT

A device includes a memory configured to store image analysis data. The device also includes one or more processors coupled to the memory and configured to use a vision encoder to process an image frame of a sequence of image frames to generate encoder output data. The one or more processors are also configured to add the encoder output data to the image analysis data used to represent the sequence of image frames for image-based cognitive analysis. The one or more processors are also configured to, based on a retention policy and a retention priority of the encoder output data, determine whether to remove the encoder output data from the image analysis data.

### I. CROSS-REFERENCE TO RELATED APPLICATIONS

The present application claims priority from Provisional Patent Application No. 63/764,255, filed Feb. 27, 2025, and entitled “PRIORITY-BASED RETENTION OF VISION ENCODER OUTPUT,” which is incorporated herein by reference in its entirety.

### FIELD

The present disclosure is generally related to vision encoding.

### DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Such computing devices often incorporate functionality to capture image frames from a camera. The image frames can be used as input for further analysis, such as generating responses to image-related queries. A computing device typically has limited storage capacity that restricts the number of image frames that can be retained for later use.

### SUMMARY

According to one implementation of the present disclosure, a device includes a memory configured to store image analysis data. The device also includes one or more processors coupled to the memory and configured to use a vision encoder to process an image frame of a sequence of image frames to generate encoder output data. The one or more processors are also configured to add the encoder output data to the image analysis data used to represent the sequence of image frames for image-based cognitive analysis. The one or more processors are also configured to, based on a retention policy and a retention priority of the encoder output data, determine whether to remove the encoder output data from the image analysis data.

According to another implementation of the present disclosure, a device includes a memory configured to store sets of encoder output data. The device also includes one or more processors coupled to the memory and configured to receive, from a vision encoder of a second device, encoder output data for image-based cognitive analysis, the encoder output data representing an image frame of a sequence of image frames. The one or more processors are also configured to, based on a retention policy and a retention priority of the encoder output data, selectively send a deletion command to the second device to remove the encoder output data from image analysis data stored at the second device.

According to another implementation of the present disclosure, a device includes a memory configured to store image analysis data. The device also includes one or more processors coupled to the memory and configured to receive encoder output data from a vision encoder of a second device, the encoder output data representing an image frame of a sequence of image frames. The one or more processors are also configured to add the encoder output data to the image analysis data used to represent the sequence of image frames for image-based cognitive analysis. The one or more processors are also configured to, based on a retention policy and a retention priority of the encoder output data, determine whether to remove the encoder output data from the image analysis data.

According to another implementation of the present disclosure, a method includes using a vision encoder to process an image frame of a sequence of image frames to generate encoder output data. The method also includes adding the encoder output data to image analysis data used to represent the sequence of image frames for image-based cognitive analysis. The method also includes, based on a retention policy and a retention priority of the encoder output data, determining whether to remove the encoder output data from the image analysis data.

According to another implementation of the present disclosure, a method includes receiving, from a vision encoder of a device, encoder output data for image-based cognitive analysis, the encoder output data representing an image frame of a sequence of image frames. The method also includes, based on a retention policy and a retention priority of the encoder output data, selectively sending a deletion command to the device to remove the encoder output data from image analysis data stored at the device.

According to another implementation of the present disclosure, a method includes receiving encoder output data from a vision encoder of a device, the encoder output data representing an image frame of a sequence of image frames. The method also includes adding the encoder output data to image analysis data used to represent the sequence of image frames for image-based cognitive analysis. The method also includes, based on a retention policy and a retention priority of the encoder output data, determining whether to remove the encoder output data from the image analysis data.

According to another implementation of the present disclosure, a non-transitory computer-readable medium stores instructions that, when executed by one or more processors, cause the one or more processors to use a vision encoder to process an image frame of a sequence of image frames to generate encoder output data. The instructions further cause the one or more processors to add the encoder output data to image analysis data used to represent the sequence of image frames for image-based cognitive analysis. The instructions further cause the one or more processors to, based on a retention policy and a retention priority of the encoder output data, determine whether to remove the encoder output data from the image analysis data.

According to another implementation of the present disclosure, a non-transitory computer-readable medium stores instructions that, when executed by one or more processors, cause the one or more processors to receive, from a vision encoder of a device, encoder output data for image-based cognitive analysis, the encoder output data representing an image frame of a sequence of image frames. The instructions further cause the one or more processors to, based on a retention policy and a retention priority of the encoder output data, selectively send a deletion command to the device to remove the encoder output data from image analysis data stored at the device.

According to another implementation of the present disclosure, a non-transitory computer-readable medium stores instructions that, when executed by one or more processors, cause the one or more processors to receive encoder output data from a vision encoder of a device, the encoder output data representing an image frame of a sequence of image frames. The instructions further cause the one or more processors to add the encoder output data to image analysis data used to represent the sequence of image frames for image-based cognitive analysis. The instructions further cause the one or more processors to, based on a retention policy and a retention priority of the encoder output data, determine whether to remove the encoder output data from the image analysis data.

According to another implementation of the present disclosure, an apparatus includes means for using a vision encoder to process an image frame of a sequence of image frames to generate encoder output data. The apparatus further includes means for adding the encoder output data to image analysis data used to represent the sequence of image frames for image-based cognitive analysis. The apparatus further includes means for determining, based on a retention policy and a retention priority of the encoder output data, whether to remove the encoder output data from the image analysis data.

According to another implementation of the present disclosure, an apparatus includes means for receiving, from a vision encoder of a device, encoder output data for image-based cognitive analysis, the encoder output data representing an image frame of a sequence of image frames. The apparatus further includes means for selectively sending, based on a retention policy and a retention priority of the encoder output data, a deletion command to the device to remove the encoder output data from image analysis data stored at the device.

According to another implementation of the present disclosure, an apparatus includes means for receiving encoder output data from a vision encoder of a device, the encoder output data representing an image frame of a sequence of image frames. The apparatus further includes means for adding the encoder output data to image analysis data used to represent the sequence of image frames for image-based cognitive analysis. The apparatus further includes means for determining, based on a retention policy and a retention priority of the encoder output data, whether to remove the encoder output data from the image analysis data.

Other aspects, advantages, and features of the present disclosure will become apparent after review of the entire application, including the following sections: Brief Description of the Drawings, Detailed Description, and the Claims.

### BRIEF DESCRIPTION OF THE DRAWINGS

FIG. 1A is a block diagram of a particular illustrative example of a system operable to perform priority-based retention of vision encoder output, in accordance with some examples of the present disclosure.

FIG. 1B is a diagram of an illustrative example of a hierarchical vision encoder, in accordance with some examples of the present disclosure.

FIG. 1C is a diagram of an illustrative example of an image-based cognitive analyzer, in accordance with some examples of the present disclosure.

FIG. 2 is a diagram of an illustrative example of a system operable to perform priority-based retention of vision encoder output, in accordance with some examples of the present disclosure.

FIG. 3 is a diagram of an illustrative example of a system operable to perform priority-based retention of vision encoder output, in accordance with some examples of the present disclosure.

FIG. 4 illustrates an example of an integrated circuit operable to perform priority-based retention of vision encoder output, in accordance with some examples of the present disclosure.

FIG. 5 is a diagram of a mobile device operable to perform priority-based retention of vision encoder output, in accordance with some examples of the present disclosure.

FIG. 6A is a diagram of a wearable electronic device operable to perform priority-based retention of vision encoder output, in accordance with some examples of the present disclosure.

FIG. 6B is a diagram of a mobile device and a wearable electronic device operable to perform priority-based retention of vision encoder output, in accordance with some examples of the present disclosure.

FIG. 7A is a diagram of a mixed reality or augmented reality glasses device operable to perform priority-based retention of vision encoder output, in accordance with some examples of the present disclosure.

FIG. 7B is a diagram of a mobile device and a mixed reality or augmented reality glasses device operable to perform priority-based retention of vision encoder output, in accordance with some examples of the present disclosure.

FIG. 8A is a diagram of a voice-controlled speaker system operable to perform priority-based retention of vision encoder output, in accordance with some examples of the present disclosure.

FIG. 8B is a diagram of a mobile device and a voice-controlled speaker system operable to perform priority-based retention of vision encoder output, in accordance with some examples of the present disclosure.

FIG. 9A is a diagram of a camera operable to perform priority-based retention of vision encoder output, in accordance with some examples of the present disclosure.

FIG. 9B is a diagram of a mobile device and a camera operable to perform priority-based retention of vision encoder output, in accordance with some examples of the present disclosure.

FIG. 10A is a diagram of a headset, such as a virtual reality, mixed reality, or augmented reality headset, operable to perform priority-based retention of vision encoder output, in accordance with some examples of the present disclosure.

FIG. 10B is a diagram of a mobile device and a headset, such as a virtual reality, mixed reality, or augmented reality headset, operable to perform priority-based retention of vision encoder output, in accordance with some examples of the present disclosure.

FIG. 11A is a diagram of a first example of a vehicle operable to perform priority-based retention of vision encoder output, in accordance with some examples of the present disclosure.

FIG. 11B is a diagram of a mobile device and the first example of a vehicle operable to perform priority-based retention of vision encoder output, in accordance with some examples of the present disclosure.

FIG. 12A is a diagram of a second example of a vehicle operable to perform priority-based retention of vision encoder output, in accordance with some examples of the present disclosure.

FIG. 12B is a diagram of a mobile device and the second example of a vehicle operable to perform priority-based retention of vision encoder output, in accordance with some examples of the present disclosure.

FIG. 13 is a diagram of a particular implementation of a method of priority-based retention of vision encoder output that may be performed by the device of FIG. 1A, in accordance with some examples of the present disclosure.

FIG. 14 is a diagram of a particular implementation of another method of priority-based retention of vision encoder output that may be performed by a device of FIG. 2, in accordance with some examples of the present disclosure.

FIG. 15 is a diagram of a particular implementation of a method of priority-based retention of vision encoder output that may be performed by a device of FIG. 3, in accordance with some examples of the present disclosure.

FIG. 16 is a block diagram of a particular illustrative example of a device that is operable to perform priority-based retention of vision encoder output, in accordance with some examples of the present disclosure.

### DETAILED DESCRIPTION

Cognitive analysis can be performed on image frames, such as to generate responses to image-related queries. Limited storage capacity at a device can restrict the number of image frames that can be stored and made available for further analysis.

Systems and methods of priority-based retention of vision encoder output are disclosed. For example, a vision encoder (e.g., a hierarchical vision encoder (HVE)) processes an image frame to generate encoder output data that represents the image frame for cognitive analysis. In an illustrative example, using a first stage of the HVE, an image frame is processed to generate first image latent data that corresponds to a first downscaled representation of the image frame. A second stage of the HVE processes the first image latent data to generate second image latent data that corresponds to a second downscaled representation of the image frame. For example, the second downscaled representation corresponds to additional downscaling of the first downscaled representation. Each subsequent stage of the HVE processes previous image latent data generated by a prior stage of the HVE to generate image latent data that corresponds to an additionally downscaled representation of the image frame. The HVE outputs image latent data generated by one or more stages as encoder output data. In an example, the HVE includes a convolutional neural network (CNN) and each stage of the HVE corresponds to a respective convolutional layer of the CNN.

The encoder output data is added to image analysis data stored in a memory. In some examples, the encoder output data is added to image analysis data stored in a local memory, transmitted to another device, or both. Subsequently, when cognitive analysis based on the image frame is to be performed, the encoder output data representing the image frame is retrieved from the memory and processed to generate a response to an image-related query.

The encoder output data typically has a smaller size than the original image frame. For example, fewer bits are used to store the encoder output data in the memory than bits that would be used to store the original image frame. Therefore, the encoder output data corresponding to a greater number of image frames can be stored in the memory more efficiently than storing the image frames themselves. Additionally, the encoder output data can be transmitted more efficiently than transmitting the image frames themselves. Consequently, data from a greater number of image frames becomes accessible for cognitive analysis.

In an example, a vision encoder (e.g., an HVE) at a first device processes an image frame of a sequence of image frames to generate encoder output data and adds the encoder output data to image analysis data in a memory. Subsequently, a retention policy manager determines, based on a retention policy and a retention priority of the encoder output data, whether to remove the encoder output data from the image analysis data. In an example, the retention policy indicates a retention criterion (e.g., encoder output data that is included in the image analysis data for less than two days is to be retained). The retention policy manager, based on determining that priority data of the encoder output data indicates that the encoder output data fails to satisfy the retention criterion (e.g., added to the image analysis data three days ago), determines that the encoder output data has low retention priority and removes the encoder output data from the image analysis data. Removing lower priority encoder output data can create space for additional sets of higher priority (e.g., more recent) encoder output data at the first device to perform image-based cognitive analysis.

In some examples, the first device sends the encoder output data to a second device for image-based cognitive analysis at the second device. A retention policy manager of the second device determines, based on the retention policy and the retention priority, whether the encoder output data is to be removed from the image analysis data. The retention policy manager, in response to determining that the encoder output data is to be removed, sends a deletion command from the second device to the first device to remove the encoder output data from the image analysis data stored at the first device. Removing lower priority encoder output data can create space for additional sets of higher priority (e.g., more recent) encoder output data at the first device for sending to the second device to perform image-based cognitive analysis.

In some examples, the first device sends the encoder output data to a second device for image-based cognitive analysis at the second device, and also to add the encoder output data to image analysis data stored at the second device. In some of these examples, a retention policy manager of the second device determines, based on the retention policy and the retention priority, whether to remove the encoder output data from the image analysis data stored at the second device. Removing lower priority encoder output data can create space for additional sets of higher priority (e.g., more recent) encoder output data at the second device to perform image-based cognitive analysis.

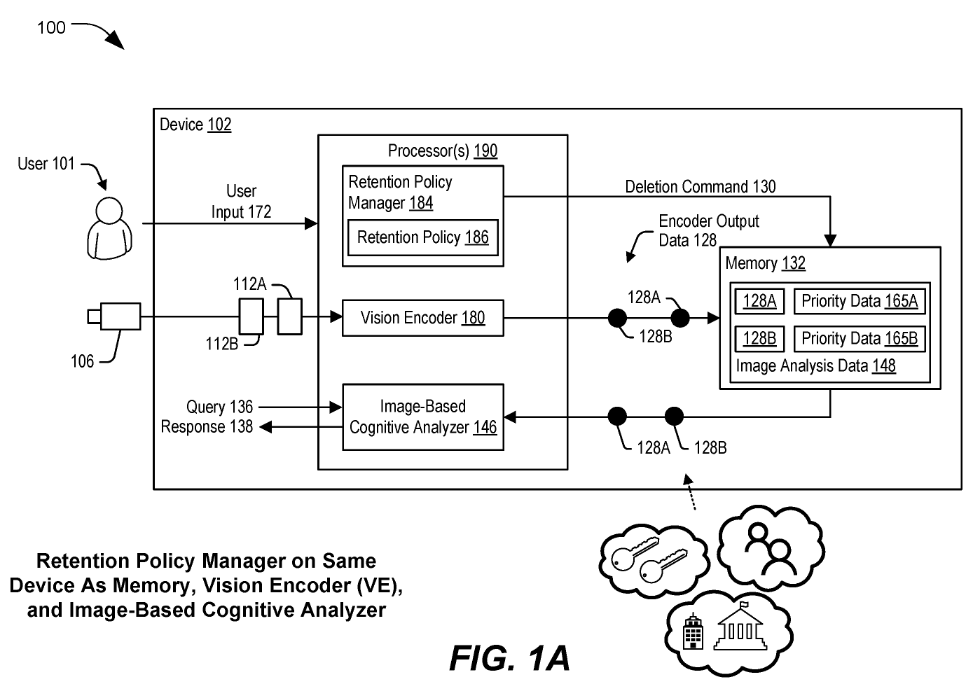

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1A depicts a device 102 including one or more processors (“processor(s)” 190 of FIG. 1A), which indicates that in some implementations the device 102 includes a single processor 190 and in other implementations the device 102 includes multiple processors 190. For ease of reference herein, such features are generally introduced as “one or more” features and are subsequently referred to in the singular or optional plural (as indicated by “(s)”) unless aspects related to multiple of the features are being described.

In some drawings, multiple instances of a particular type of feature are used. Although these features are physically and/or logically distinct, the same reference number is used for each, and the different instances are distinguished by addition of a letter to the reference number. When the features as a group or a type are referred to herein e.g., when no particular one of the features is being referenced, the reference number is used without a distinguishing letter. However, when one particular feature of multiple features of the same type is referred to herein, the reference number is used with the distinguishing letter. For example, referring to FIG. 1A, multiple image frames are illustrated and associated with reference numbers 112A and 112B. When referring to a particular one of these image frames, such as an image frame 112A, the distinguishing letter “A” is used. However, when referring to any arbitrary one of these image frames or to these image frames as a group, the reference number 112 is used without a distinguishing letter.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “obtaining,” “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “obtaining,” “generating,” “calculating,” “estimating,” “using,” “selecting,” “accessing,” and “determining” may be used interchangeably. For example, “obtaining,” “generating,” “calculating,” “estimating,” or “determining” a parameter (or a signal) may refer to actively generating, estimating, calculating, or determining the parameter (or the signal) or may refer to using, selecting, receiving, or accessing the parameter (or signal) that is already generated, such as by another component or device.

As used herein, the term “latent data” should be understood in accordance with any of its usual and customary meanings in the fields of computer science, data science, and/or machine learning. For example, latent data can be generated by a machine-learning model as a representation of data input to the machine-learning model. Generally, the latent data include values representing underlying patterns, structures, or features that the machine-learning model infers from the input data. Ideally, the latent data represents the input data in a manner that includes important and/or unique characteristics of the input data in view of a goal or purpose of the machine-learning model. To illustrate, image latent data described herein includes latent data representing characteristics of one or more images in a manner that is useful for image-based cognitive analysis.

As used herein, the term “hierarchical vision encoder” should be understood in accordance with any of its usual and customary meanings in the fields of computer science, data science, and/or machine learning. Generally, a hierarchical vision encoder corresponds to an encoder that includes at least two stages and is configured to process image data in a hierarchical manner (e.g., output of one stage is provided as input, possibly along with other data, to a subsequent stage). To illustrate, a hierarchical vision encoder described herein includes at least a first stage and a second stage. The first stage is configured to process image data of an image frame to generate first stage output (e.g., first image latent data) corresponding to a representation (e.g., a downscaled representation) of the image frame. The second stage is configured to process the first stage output (e.g., the first image latent data) to generate second stage output (e.g., second image latent data) corresponding to a representation (e.g., an additionally downscaled representation) of the image frame. The hierarchical vision encoder is configured to generate encoder output data that is based on output of one or more of the stages.

As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows – a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference.

In some implementations, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so called “transfer learning.” In transfer learning a base model may be trained using a generic or typical data set, and the base model may be subsequently refined (e.g., re-trained or further trained) using a more specific data set.

A data set used during training is referred to as a “training data set” or simply “training data”. The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

Referring to FIG. 1A, a particular illustrative aspect of a system configured to perform priority-based retention of vision encoder output is disclosed and generally designated 100. The system 100 includes a device 102 that includes one or more processors 190 coupled to a memory 132. The one or more processors 190 are also coupled to an image source 106. The one or more processors 190 include a vision encoder 180 (e.g., a hierarchical vision encoder (HVE)), a retention policy manager 184, and optionally an image-based cognitive analyzer 146. The memory 132 is coupled to the retention policy manager 184 and optionally to the image-based cognitive analyzer 146. It should be understood that the image-based cognitive analyzer 146 is provided as an illustrative example of an image-based analyzer configured to process encoder output data of the vision encoder 180; in other examples the device 102 can include one or more other types of image-based analyzers configured to process encoder output data of the vision encoder 180.

The image source 106 is depicted as a video camera external to the device 102 as an illustrative example, in some other examples, the image source 106 can be integrated into the device 102. In some examples, the image source 106 can include various types of image sources, such as a still camera, a synthetic image generation device (e.g., a graphical processing unit (GPU)), a network device, a storage device, a communication device, or a combination thereof. The image source 106 is configured to provide a sequence of image frames 112 to the one or more processors 190. In a particular aspect, the sequence of image frames 112 includes an image frame 112A, an image frame 112B, one or more additional image frames, or a combination thereof.

The vision encoder 180 is configured to process an image frame 112 to generate encoder output data 128. In some aspects, the encoder output data 128 corresponds to a downscaled representation of the image frame 112, as further described with reference to FIG. 1B. For example, the vision encoder 180 corresponds to an HVE that includes a plurality of stages. An initial stage is configured to process an image frame 112 to generate first image latent data corresponding to a downscaled representation of the image frame 112. Each subsequent stage is configured to process previous image latent data generated by a prior stage to generate subsequent image latent data. The previous image latent data corresponds to a representation of a previous image frame (e.g., a downscaled version of the image frame 112) and the subsequent image latent data corresponds to a downscaled representation of the previous image frame (e.g., an additionally downscaled version of the image frame 112). A last stage is configured to process image latent data generated by a prior stage to generate the encoder output data 128. Optionally, in some embodiments, the vision encoder 180 includes a convolutional neural network (CNN), and a particular convolutional layer of the CNN corresponds to a respective stage of the vision encoder 180. It should be understood that an HVE and a CNN are provided as illustrative examples of the vision encoder 180; in other examples the vision encoder 180 can include other types of image encoders. The encoder output data 128 represents the image frames 112. In some examples, an image frame 112 can depict sensitive information, people, homes, offices, etc., and storing or transmitting the encoder output data 128 instead of the image frames 112 enhances security.

The retention policy manager 184 is configured to, based on a retention policy 186 and priority data 165 of the encoder output data 128, determine whether to remove the encoder output data 128 from image analysis data 148. The image analysis data 148 is used to represent the sequence of image frames 112 for image-based cognitive analysis. In a particular aspect, the retention policy 186 is based on default data, a configuration setting, a user input, or a combination thereof. The retention policy 186 indicates various encoder output data characteristics and corresponding priorities. In some aspects, the encoder output data characteristics include a generation time of encoder output data, a response generation time at which an answer to a query is identified in a corresponding image frame 112, an object depicted in the corresponding image frame 112, a person depicted in the corresponding image frame 112, a location associated with the corresponding image frame 112, user input, query history, response history, or a combination thereof.

The vision encoder 180, the image-based cognitive analyzer 146, or both, are configured to generate (e.g., update) priority data 165 of encoder output data 128. In a particular aspect, the priority data 165 indicates characteristics of the corresponding encoder output data 128. The retention policy manager 184 is configured to, based on a comparison of the retention policy 186 and the priority data 165, determine a priority of the encoder output data 128. The retention policy manager 184 is configured to perform priority-based retention of the encoder output data 128. For example, the retention policy manager 184 is configured to determine whether to retain or remove the encoder output data 128 from the image analysis data 148 based on the priority.

The image-based cognitive analyzer 146 is configured to use encoder output data 128 to perform image-based cognitive analysis. For example, the image-based cognitive analyzer 146 is configured to process encoder output data 128 of one or more image frames 112 to generate a response 138 to a query 136, as further described with reference to FIG. 1C. To illustrate, the image-based cognitive analyzer 146 is configured to generate image tokens based on the encoder output data 128, generate linguistic tokens based on the query 136, generate an input embedding based on the image tokens and the linguistic tokens, and use a large language model (LLM) to process the input embedding to generate the response 138.

The memory 132 is configured to store data used or generated by one or more components of the device 102. For example, the memory 132 is configured to store one or more of an image frame 112, sets of encoder output data 128, priority data 165, image analysis data 148, the query 136, the response 138, or additional data. In some aspects, the memory 132 includes an image buffer, a data transmission buffer, a data receipt buffer, or a combination thereof.

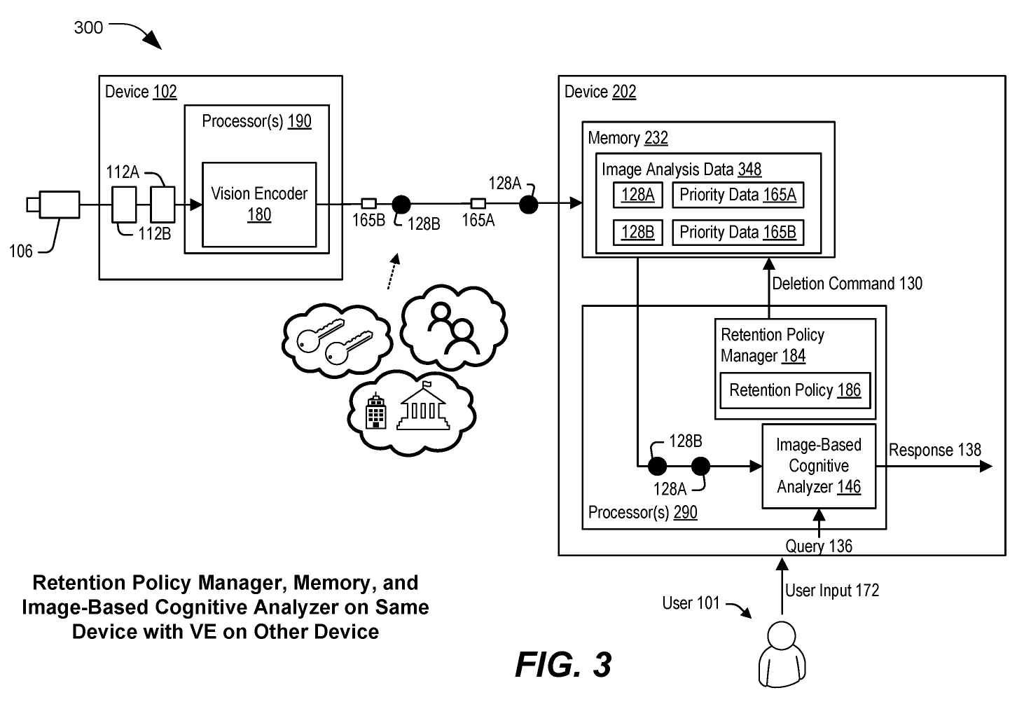

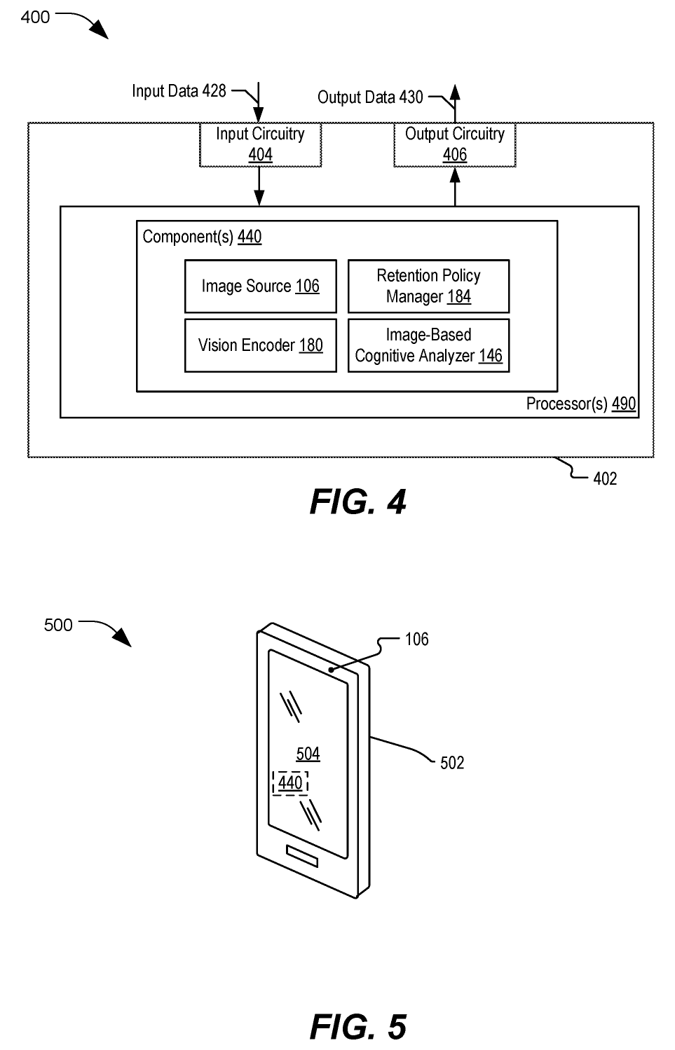

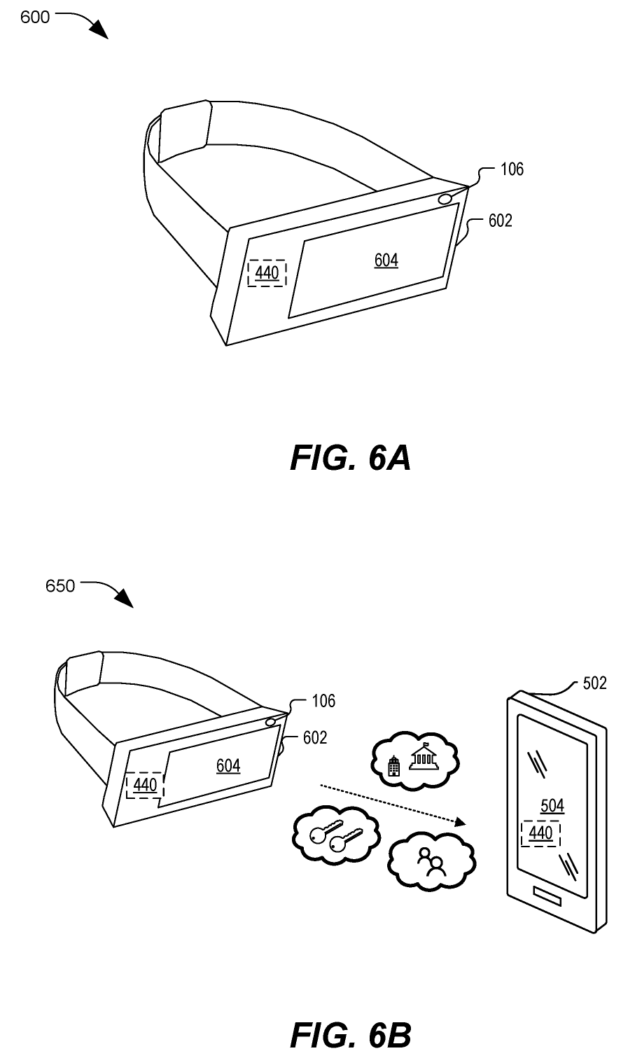

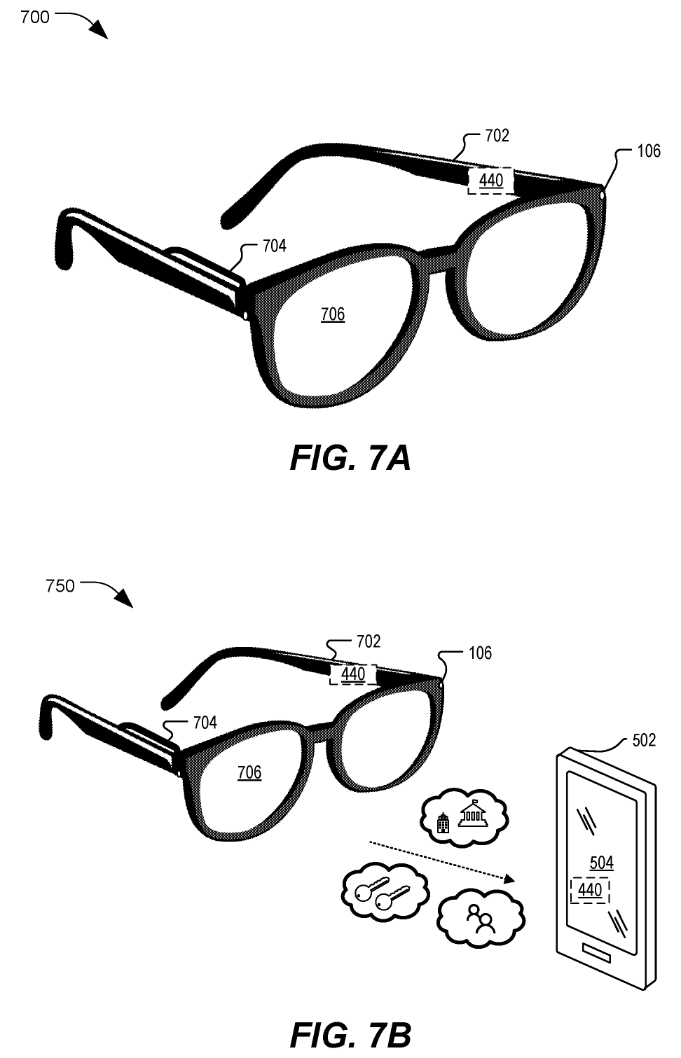

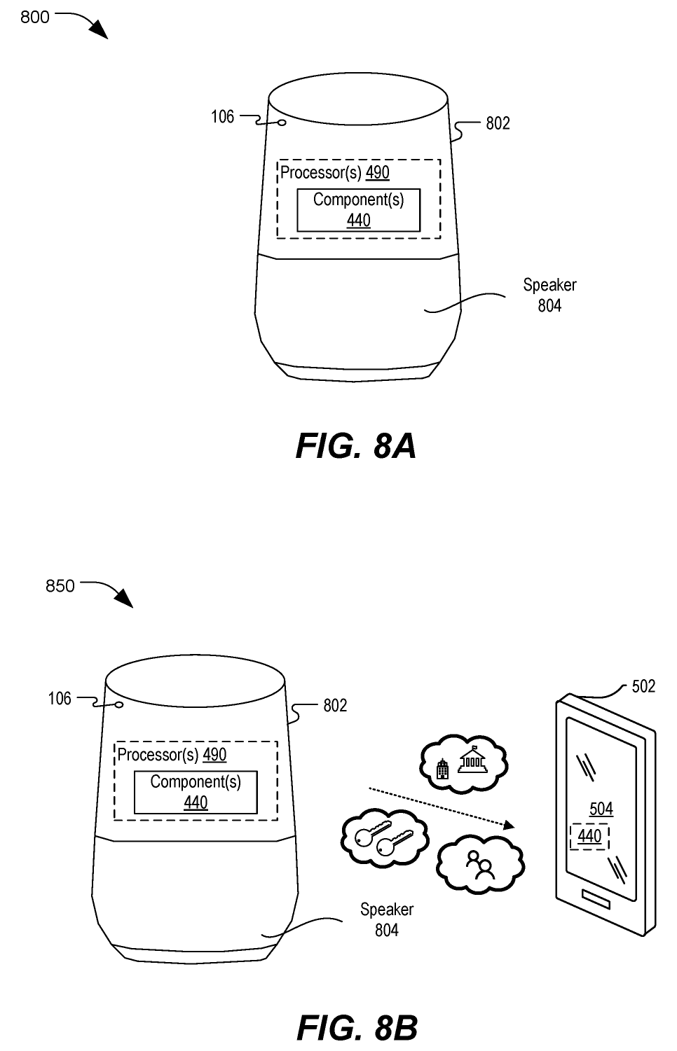

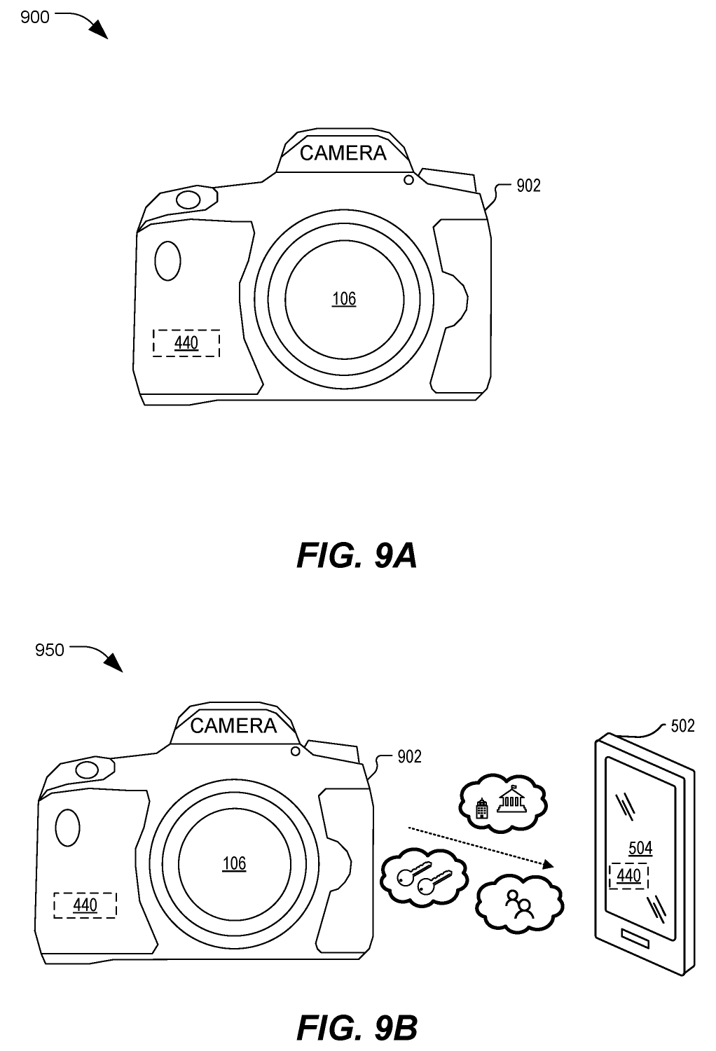

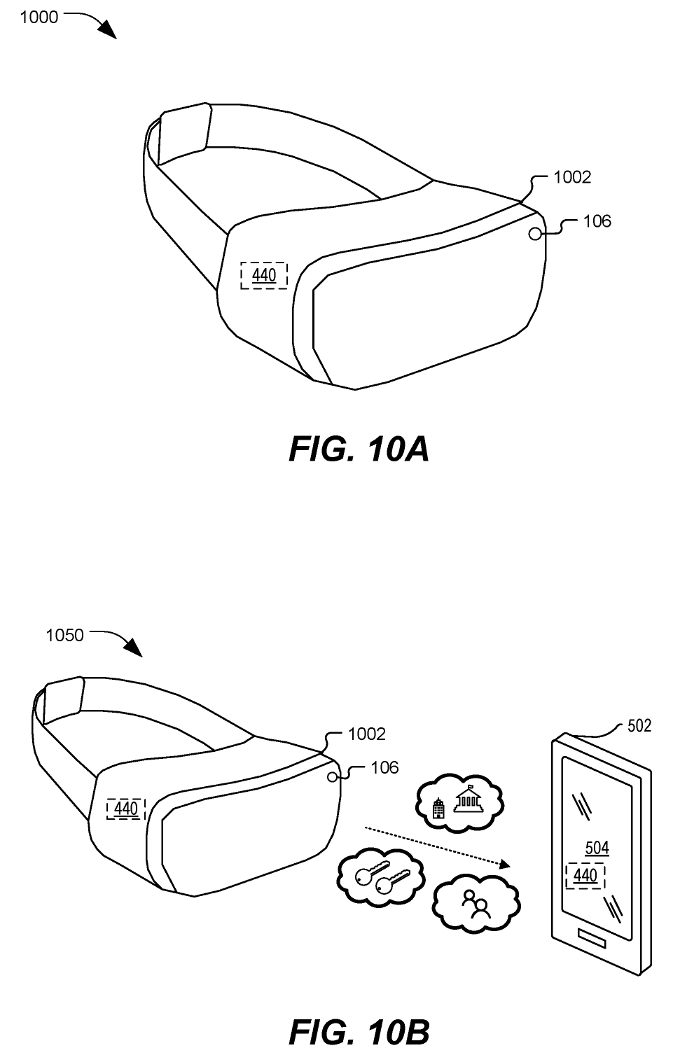

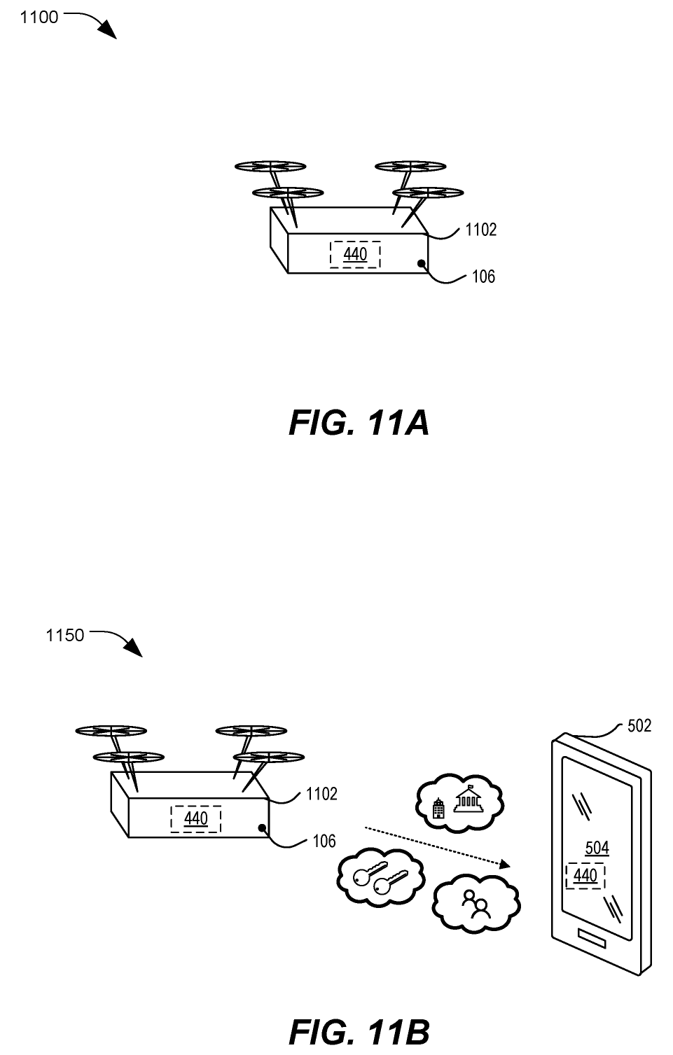

In some embodiments, the device 102 corresponds to or is included in one of various types of devices. In an illustrative example, the one or more processors 190 are integrated in at least one of a mobile phone or a tablet computer device, as described with reference to FIG. 5, a wearable electronic device, as described with reference to FIG. 6A, a mixed reality or augmented reality glasses device, as described with reference to FIG. 7A, a voice-controlled speaker system, as described with reference to FIG. 8A, a camera device, as described with reference to FIG. 9A, or a virtual reality, mixed reality, or augmented reality headset, as described with reference to FIG. 10A. In another illustrative example, the one or more processors 190 are integrated into a vehicle, such as described further with reference to FIGS. 11A and 12A.

During operation, the image source 106 (e.g., a phone camera) of a user 101 provides an image frame 112A of a sequence of image frames 112 to the vision encoder 180. The vision encoder 180 processes the image frame 112A to generate encoder output data 128A corresponding to a representation (e.g., a downscaled representation) of the image frame 112A, as further described with reference to FIG. 1B. In some aspects, the encoder output data 128A includes a plurality of image feature embeddings that correspond to the downscaled representation of the image frame 112A. In some examples, the encoder output data 128A includes image encoding data (e.g., a set of identifiers) that is based on the plurality of image feature embeddings. The vision encoder 180 stores the encoder output data 128A in the memory 132. For example, the vision encoder 180 adds the encoder output data 128A to image analysis data 148 used to represent the sequence of image frames 112 for image-based cognitive analysis. The image analysis data 148 is stored in the memory 132.

In a particular aspect, the encoder output data 128A is designated as associated with (e.g., representative of) the image frame 112A. In an example, the encoder output data 128A is designated as associated with a timestamp of the image frame 112A, a location of the image source 106 when the image frame 112A is captured, a user identifier of a user 101 that is logged into the device 102 when the image frame 112A is obtained, or a combination thereof.

In some examples, the vision encoder 180 generates priority data 165A associated with the encoder output data 128A. For example, the vision encoder 180 performs object detection on the image frame 112A to detect one or more objects and generates priority data 165A indicating the detected object(s). As another example, the vision encoder 180, based on determining that the image frame 112A is associated with a location, generates the priority data 165A indicating the location. As another example, the vision encoder 180 generates the priority data 165A indicating a time (e.g., a capture time, a receipt time, or both) associated with the image frame 112A, a generation time of the encoder output data 128A, or both. In some aspects, the vision encoder 180 adds priority data 165A to the image analysis data 148 concurrently with adding the encoder output data 128A to the image analysis data 148. The vision encoder 180 designates the priority data 165A as associated with the encoder output data 128A.

Optionally, in some embodiments, the vision encoder 180, subsequent to processing the image frame 112A to generate the encoder output data 128A, discards the image frame 112A. To illustrate, the image frame 112A is stored in the memory 132 (e.g., an image buffer) and the vision encoder 180 marks the image frame 112A for deletion from the memory 132.

In some aspects, similar operations are performed to process additional image frames of the sequence of image frames 112. For example, the image source 106 provides an image frame 112B of the sequence of image frames 112 to the vision encoder 180. The vision encoder 180 processes the image frame 112B to generate encoder output data 128B and adds the encoder output data 128B to the image analysis data 148. In some examples, the vision encoder 180 generates priority data 165B associated with the encoder output data 128B, adds the priority data 165 to the image analysis data 148, and designates the priority data 165B as associated with the encoder output data 128B. Optionally, in some embodiments, the vision encoder 180, subsequent to processing the image frame 112B to generate the encoder output data 128, discards the image frame 112B.

Subsequently, the image-based cognitive analyzer 146 receives a query 136 related to the sequence of image frames 112. In a particular aspect, the image-based cognitive analyzer 146 receives, from a user 101, user input 172 indicating the query 136. In some aspects, the query 136 indicates a set of image frames 112 of interest. For example, the query 136 (e.g., “where did I leave my keys in the last one hour?”) indicates a target time interval (e.g., captured in the last one hour) of the set of image frames 112 of interest. The image-based cognitive analyzer 146, based on determining that the query 136 is associated with one or more image frames 112, retrieves encoder output data 128 from the image analysis data 148 stored in the memory 132. For example, the image-based cognitive analyzer 146, based on determining that query 136 is associated with the image frame 112A, retrieves the encoder output data 128A from the memory 132 corresponding to the image frame 112A.

In some examples, the image-based cognitive analyzer 146, responsive to retrieving the encoder output data 128A at a first time from the image analysis data 148, updates the priority data 165A to indicate the first time as a most recent retrieval time of the encoder output data 128A. To illustrate, the most recent retrieval time can correspond to the most recent use of the encoder output data 128A in image-based cognitive analysis.

The image-based cognitive analyzer 146 performs image-based cognitive analysis based on the encoder output data 128A to generate a response 138 to the query 136, as further described with reference to FIG. 1C. The image-based cognitive analysis includes processing linguistic inputs and image-based inputs using a multimodal transformer network. For example, the image-based cognitive analyzer 146 generates image tokens based on the encoder output data 128A and linguistic tokens based on the query 136, generates an input embedding based on the image tokens and the linguistic tokens, uses a multimodal transformer network (e.g., an LLM) to perform image-based cognitive analysis based on the input embedding to generate the response 138. The response 138 can include text, audio, or both. If the response 138 corresponds to an answer to the query 136 that is identified in the image frame 112A, the response 138 can indicate image-related data associated with the encoder output data 128A. For example, if the response 138 indicates that a queried object (e.g., the key) was most recently detected in the image frame 112A, the response 138 can indicate a time, a location, a user, or a combination thereof associated with the encoder output data 128A.

In some examples, the image-based cognitive analyzer 146, in response to generating the response 138 at a second time based on determining that an answer to the query 136 is identified in the image frame 112A corresponding to the encoder output data 128A, updates the priority data 165A to indicate the second time as the most recent response generation time associated with the encoder output data 128A.

In a particular aspect, the image-based cognitive analyzer 146 outputs the response 138 to the user 101. In an example, the image-based cognitive analyzer 146 provides the response 138 to a display device, a communication device, a speaker, or a combination thereof.

Subsequently, the retention policy manager 184 determines whether a deletion trigger condition is satisfied. For example, the retention policy manager 184 determines that a deletion trigger condition is satisfied based on determining that available space in the memory 132 is less than a threshold, that available space designated for the image analysis data 148 in the memory 132 is less than a threshold, that a threshold time has elapsed since previous deletion of encoder output data 128 from the image analysis data 148, a user input 172 is received indicating that clean-up of the image analysis data 148 is to be performed, a timer has elapsed, or a combination thereof.

The retention policy manager 184, based on determining that a deletion trigger condition is satisfied, determines retention priority of the encoder output data 128. For example, the retention policy 186 indicates various encoder output data characteristics and corresponding priorities. The priority data 165 indicates characteristics of the encoder output data 128. The retention policy manager 184 determines a priority of the encoder output data 128 based on the retention policy 186 and the priority data 165. For example, the retention policy manager 184, based on determining that the retention policy 186 indicates that characteristics of the encoder output data 128A (as indicated by the priority data 165A) correspond to a particular retention priority, determines that the priority data 165A indicates the particular retention priority of the encoder output data 128A and assigns the particular retention priority to the encoder output data 128A.

In an illustrative example, the retention policy 186 indicates that any image frame 112 that depicts a particular object (e.g., a key) has higher priority than other image frames 112 that do not depict the object. In an example, the priority data 165A indicates that the image frame 112A does not depict the object, and the priority data 165B indicates that the image frame 112B depicts the object. In this example, the retention policy manager 184, based on determining that the retention policy 186 indicates that not depicting the object is associated with a first retention priority (e.g., lower priority) and that the priority data 165A indicates that the object is not depicted, determines that the priority data 165A indicates that the encoder output data 128A has the first retention priority (e.g., a low retention priority) and assigns the first retention priority to the encoder output data 128A. Similarly, the retention policy manager 184, based on determining that the retention policy 186 indicates that depicting the object is associated with a second retention priority (e.g., higher priority) and that the priority data 165B indicates that the object is depicted, determines that the priority data 165B indicates that the encoder output data 128B has the second retention priority (e.g., a high retention priority) and assigns the second retention priority to the encoder output data 128B.

It should be understood that retention priority based on depicting an object is provided as an illustrative example, in other examples the retention priority can be based on multiple criteria (e.g., a weighted average), such as a detected object, a location, a time associated with an image frame 112, a generation time of the encoder output data 128, a most recent retrieval time of the encoder output data 128A, a most recent use time of the encoder output data 128A, a most recent response generation time, a user input, or a combination thereof. For example, the retention policy manager 184, in response to receiving a user input 172 from the user 101 indicating that the image frame 112B, the encoder output data 128B, or both, are to be designated as having a second retention priority (e.g., high priority), updates the priority data 165B to indicate that the encoder output data 128B has the second retention priority based on user input.

The retention policy manager 184 determines whether to remove the encoder output data 128 based on the priority of the encoder output data 128. For example, the retention policy manager 184 sorts the encoder output data 128 based on retention priority and removes the encoder output data 128 having the lowest retention priority. To illustrate, the retention policy manager 184, based on determining that the first retention priority indicated by the priority data 165A is lower than the second retention priority indicated by the priority data 165B, removes the encoder output data 128A and the priority data 165A from the image analysis data 148. In another example, the retention policy manager 184, in response to identifying encoder output data 128 associated with a priority that is less than a threshold, removes the encoder output data 128 from the image analysis data 148. To illustrate, the retention policy manager 184, based on determining that the first retention priority indicated by the priority data 165A is lower than a priority threshold, removes the encoder output data 128A and the priority data 165A from the image analysis data 148. In an example, the retention policy manager 184 sends a deletion command 130 to the memory 132 to delete the encoder output data 128A, the priority data 165A, or both.

A technical advantage of the system 100 includes accessibility to data associated with more image frames 112 for cognitive analysis. For example, the encoder output data 128A is smaller than the image frame 112A. With limited storage capacity, sets of encoder output data 128 corresponding to more image frames 112 can be stored in the memory 132 than original image frames 112.

Another technical advantage of the system 100 includes improved accessibility to higher priority encoder output data 128 for image-based analysis. For example, the encoder output data 128 that has higher priority is retained longer for cognitive analysis. Additionally, lower priority encoder output data 128 can be removed to make space for more encoder output data 128.

In some examples, based on an output of the vision encoder 180, the image-based cognitive analyzer 146, a neural network, a machine-learning model, or a combination thereof, one or more components of a device (e.g., the device 102) can perform various operations such as: i) controlling a machine such as a vehicle, a robot, an appliance, a mobile device, a camera; ii) controlling an actuator such as an electromechanical actuator, an electrohydraulic actuator, an electroactive polymer actuator; iii) controlling an active circuit component such as a voltage or current source, a transistor, an amplifier, an integrated circuit, a programmable device such as field-programmable gate array (FPGA), a display device; iii) providing a notification to a user, such as a visual, auditory or haptic notification or combination thereof, iv) launching, closing, pausing or suspending an application on a computer; iv) launching, closing, pausing or suspending playback of audio video (AV) media on a computer; or v) providing a control signal to initiate any of the above.

Referring to FIG. 1B, an illustrative example of the vision encoder 180 is disclosed, in accordance with some examples of the present disclosure. The vision encoder 180 corresponds to an HVE that includes a plurality of stages 140, such as a stage 140A, a stage 140B, one or more additional stages 140, a stage 140Y, or a combination thereof. It should be understood that the vision encoder 180 is depicted as including 3 stages 140 as an illustrative example; in other examples the vision encoder 180 can include fewer than 3 or more than 3 stages 140.

Each stage 140 of the vision encoder 180 includes a multi-context local attention 160. For example, the stage 140A includes a multi-context local attention 160A, the stage 140B includes a multi-context local attention 160B, the stage 140Y includes a multi-context local attention 160Y, and so on. One or more of the stages 140 of the vision encoder 180 include a downscaling layer 162 (e.g., a pooling layer or a convolution layer). For example, the stage 140A includes a downscaling layer 162A, the stage 140B includes a downscaling layer 162B, and so on. In some embodiments, the last stage (e.g., the stage 140Y) does not include a downscaling layer 162.

The multi-context local attention 160A processes data representing an image frame 112 to generate image latent data 164A. In an example, a multi-context local attention 160 is configured to capture dependencies across different parts of an input. To illustrate, the multi-context local attention 160 performs feature extraction by integrating contextual information to generate image latent data 164.

The image frame 112 has a height (H), a width (W), and channels (C). The image latent data 164A includes first image feature embeddings representing the image frame 112 having the height (H) and the width (W). An image feature embedding has an embedding dimension (D) that indicates a count of features (e.g., numerical values) represented in the image feature embedding.

The downscaling layer 162A processes the image latent data 164A to generate image latent data 166A. The image latent data 166A includes second image feature embeddings that represent a downscaled representation of the image frame 112. For example, the downscaled representation has a height (H/r) and a width (W/r), where r corresponds to a downscaling factor. In some embodiments, a second image feature embedding of image latent data 166 has the same dimensionality (D) as a first image feature embedding of image latent data 164. In some embodiments, a count of the second image feature embeddings included in the image latent data 166 that is output by a downscaling layer 162 is fewer than a count of the first image feature embeddings included in the image latent data 164 input to the downscaling layer 162.

Optionally, in some embodiments, similar operations are performed at one or more intermediate stages 140 of the vision encoder 180 based on output of respective previous stages 140. For example, the multi-context local attention 160B processes the image latent data 166A to generate image latent data 164B. The downscaling layer 162B processes the image latent data 164B to generate image latent data 166B. The image latent data 166B includes third image feature embeddings that represent a downscaled representation of the image frame 112. For example, the downscaled representation has a height (H/r²) and a width (W/r²), where each of the downscaling layers 162A and 162B have the same downscaling factor (r). To illustrate, the third image feature embeddings of the image latent data 166B correspond to a downscaled representation of an image frame represented by the second image frame embeddings of the image latent data 166A. In some embodiments, a count of the third image feature embeddings included in the image latent data 166B that is output by the downscaling layer 162B is fewer than a count of the second image feature embeddings included in the image latent data 166A that is output by the downscaling layer 162A.

At the stage 140Y (e.g., a last stage of the stages 140), the multi-context local attention 160B processes the image latent data 166X (e.g., image latent data 166 generated by a previous stage 140) to generate the encoder output data 128. The encoder output data 128 corresponds to a downscaled representation of the image frame 112. In some aspects, the downscaled representation has a height (H/r^{x}) and a width (W/r^{x}), where x is a count of stages prior to the stage 140Y. In an example, the encoder output data 128 includes fourth image feature embeddings, and each image feature embedding has an embedding dimension (D). In some aspects, a count of the fourth image feature embeddings of the encoder output data 128 is fewer than a count of the first image feature embeddings of the image latent data 164A. For example, the fourth image feature embeddings correspond to a downscaled representation (e.g., an image frame having a height (H/r^{x}) and a width (W/r^{x})) as compared to the first image frame embeddings corresponding to the image frame 112 (e.g., having a height (H) and a width (W)).

It should be understood that a stage 140 can include one or more additional layers or components that are not shown, such as one or more of a normalization layer, a convolution layer, a pooling layer, etc. In an example 182, various types of normalizations are depicted, such as batch normalization, layer normalization, instance normalization, and group normalization. Height (H) and width (W) correspond to spatial dimensions of an image frame 112, C corresponds to channels in the image frame 112, and N corresponds to a batch size.

A technical advantage of the vision encoder 180 includes retaining characteristics of the image frames 112 in the encoder output data 128 with a reduced size, as compared to the original image frame 112 and also as compared to the image latent data 164A. The smaller size of the encoder output data 128 enables conservation of resources (e.g., memory, bandwidth, or both).

Referring to FIG. 1C, an illustrative example of the image-based cognitive analyzer 146 is disclosed, in accordance with some examples of the present disclosure. The image-based cognitive analyzer 146 includes a projector 170 and a tokenizer 185 that are each coupled to an embedding generator 174. The embedding generator 174 is coupled to a multimodal transformer network 178. In some aspects, the multimodal transformer network 178 corresponds to (e.g., includes) an LLM. In a particular aspect, the image-based cognitive analyzer 146 can be included in the device 102 of FIG. 1A.

During operation, the tokenizer 185 processes the query 136 to generate linguistic tokens 187 that represent the query 136 in a token space. In an example, the tokenizer 185 breaks up the query 136 into linguistic segments, such as subwords, words, characters, other types of segments, or a combination thereof. The tokenizer 185 outputs linguistic tokens 187 (e.g., numerical values) corresponding to the linguistic segments. To illustrate, a linguistic token 187 (e.g., a numerical value) represents a corresponding linguistic segment in the token space.

The image-based cognitive analyzer 146 receives the encoder output data 128A corresponding to the image frame 112A, as described with reference to FIG. 1A. In an example 192, the encoder output data 128A includes (or corresponds to) an image feature embedding (FE) 154A, an image FE 154B, one or more additional FEs, or a combination thereof. To illustrate, in a particular aspect, the encoder output data 128A includes image FEs 154. In another aspect, the encoder output data 128A includes image encoding data (e.g., a set of identifiers) and the image encoding data can be used to determine corresponding image FEs 154.

The projector 170 processes each image FE 154 to generate a corresponding set of image tokens 173. For example, the projector 170 processes the image FE 154A to generate a set of image tokens 173A, the image FE 154B to generate a set of image tokens 173B, and so on. A set of image tokens 173 represents a corresponding image FE 154 in a token space. In a particular aspect, the set of image tokens 173A and the linguistic tokens 187 are associated with the same token space and can be processed together by the multimodal transformer network 178.

The embedding generator 174 generates an input embedding 176A based on the set of image tokens 173A and the linguistic tokens 187. For example, the embedding generator 174 concatenates the set of image tokens 173A and the linguistic tokens 187 to generate the input embedding 176A. The multimodal transformer network 178 processes the input embedding 176A to generate the response 138. In a particular aspect, the response 138 includes a synthetic image, text, audio, or a combination thereof.

Similarly, the image-based cognitive analyzer 146 processes one or more additional image FEs 154 of the encoder output data 128A associated with the image frame 112A and continues to generate (e.g., update) the response 138. For example, the projector 170 processes the image FE 154B to generate a set of image tokens 173B. The embedding generator 174 generates an input embedding 176B based on the set of image tokens 173B and the linguistic tokens 187. The multimodal transformer network 178 processes the input embedding 176B to generate (e.g., update) the response 138.

In a particular aspect, the image-based cognitive analyzer 146 processes encoder output data 128 corresponding to one or more additional image frames 112 and continues to generate (e.g., update) the response 138. For example, the image-based cognitive analyzer 146 processes the encoder output data 128B corresponding to the image frame 112B to generate (e.g., update) the response 138.

A technical advantage of the image-based cognitive analyzer 146 includes enabling generation of a response 138 to the query 136 based on the encoder output data 128 that represents image features of downsampled representations of the image frames 112 without having access to the original image frames 112. For example, the vision encoder 180 of FIG. 1A can process an image frame 112A to generate the encoder output data 128A and the image frame 112A can be discarded. The encoder output data 128A can be used to generate the response 138.

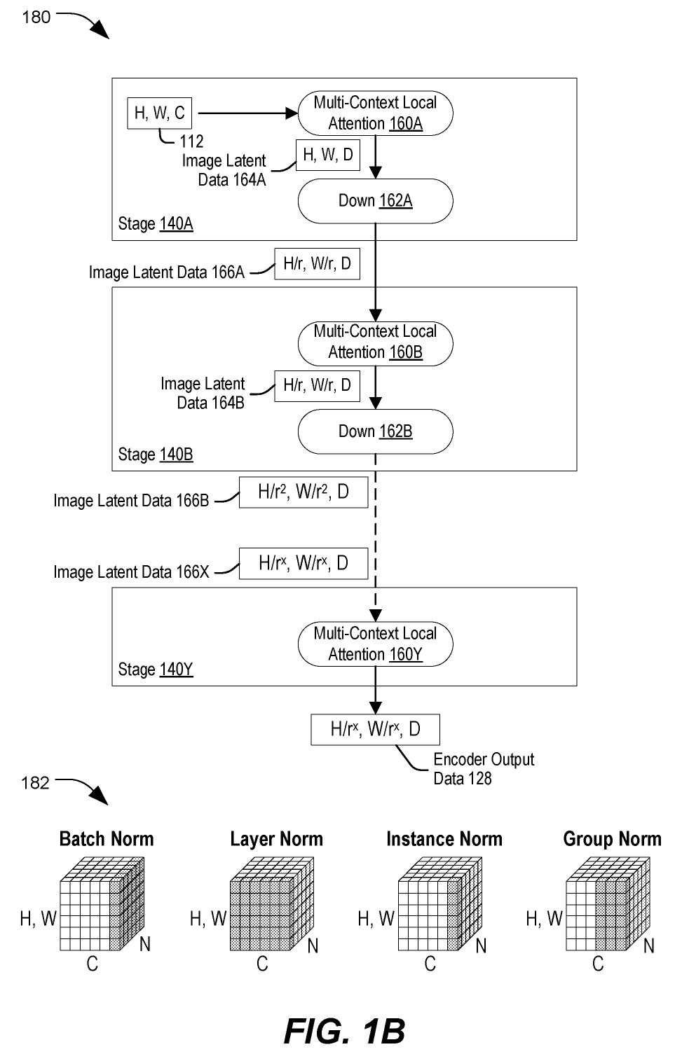

Referring to FIG. 2, a particular illustrative aspect of a system configured to perform priority-based retention of vision encoder output is disclosed and generally designated 200, in accordance with some examples of the present disclosure. The system 200 includes the device 102 coupled to one or more devices 202.

A device 202 includes one or more processors 290 coupled to a memory 232. The memory 232 is configured to store data used or generated by one or more components of the device 202. For example, the memory 232 is configured to store one or more of sets of encoder output data 128, priority data 165, image analysis data 148, the query 136, the response 138, or additional data. The one or more processors 290 include the image-based cognitive analyzer 146 and the retention policy manager 184. The vision encoder 180 is included in the one or more processors 190 of the device 102. The image analysis data 148 is stored at the memory 132 of the device 102. The vision encoder 180, the image-based cognitive analyzer 146, or both, are configured to generate (e.g., update) the priority data 165 stored in the image analysis data 148, as described with reference to FIG. 1A. In some aspects, the image-based cognitive analyzer 146 is configured to maintain (e.g., update) a local version of the priority data 165 in the memory 232.

In a non-limiting illustrative example, the device 102 can correspond to extended reality (XR) glasses and the device 202 can correspond to a companion device (e.g., a phone, a gaming system, a network device, a server, or a combination thereof) that has more computational resources to perform the image-based analysis.

During operation, the vision encoder 180 processes the image frame 112A to generate the encoder output data 128A, as described with reference to FIG. 1A. The vision encoder 180 adds the encoder output data 128A to a memory 132. For example, the vision encoder 180 adds the encoder output data 128A to image analysis data 148 used to represent the sequence of image frames 112 for image-based cognitive analysis. In a particular aspect, the vision encoder 180 generates the priority data 165A and adds the priority data 165A to the image analysis data 148, as described with reference to FIG. 1A.

Similarly, the vision encoder 180 processes one or more additional image frames of the sequence of image frames 112. For example, the vision encoder 180 processes the image frame 112B to generate the encoder output data 128B and adds the encoder output data 128B to the image analysis data 148 stored in the memory 132. In some examples, the vision encoder 180 generates the priority data 165B and adds the priority data 165B to the image analysis data 148. In a particular aspect, the memory 132 includes a transmission (TX) buffer and the image analysis data 148 is stored in the TX buffer.

The device 102 transmits encoder output data 128 to the device 202. For example, the device 102 initiates transmission of the encoder output data 128A, the encoder output data 128B, or both, to the device 202. In some examples, the device 102 transmits the priority data 165 to the device 202. For example, the device 102 initiates transmission of the priority data 165A, the priority data 165B, or both.

In some aspects, the vision encoder 180, responsive to generating encoder output data 128, initiates transmission of the encoder output data 128 and optionally corresponding priority data 165. In some aspects, the device 102, responsive to receiving a request from the image-based cognitive analyzer 146 indicating an image frame 112, initiates transmission of the corresponding encoder output data 128 and optionally the corresponding priority data 165 to the device 102.

The device 202 receives the encoder output data 128 and optionally the corresponding priority data 165 from the device 102. For example, the device 202 receives the encoder output data 128A, the encoder output data 128B, the priority data 165A, the priority data 165B, or a combination thereof. In some examples, the device 202 temporarily stores encoder output data 128 in the memory 232 for the image-based cognitive analyzer 146 to generate a response 138, and the image-based cognitive analyzer 146 removes the encoder output data 128 from the memory 232 subsequent to generating the response 138. In some aspects, the device 202, in response to receiving the priority data 165, stores the priority data 165 in the memory 232.

The image-based cognitive analyzer 146 of the device 202 generates, based on the encoder output data 128A, the encoder output data 128B, or both, a response 138 to the query 136, as described with reference to FIG. 1A. In some aspects, the device 202 outputs the response 138 to a display device, a speaker, a network device, the device 102, or a combination thereof. In some examples, the image-based cognitive analyzer 146 generates (e.g., updates) the priority data 165 and stores the priority data 165 in the memory 232.

The retention policy manager 184 determines whether encoder output data 128 is to be removed from the image analysis data 148, as described with reference to FIG. 1A. For example, the retention policy manager 184 determines whether the encoder output data 128A is to be removed from the image analysis data 148. The retention policy manager 184, in response to determining that the encoder output data 128A is to be removed, sends the deletion command 130 to the device 102 to delete the encoder output data 128A, the priority data 165A, or both, from the memory 132.

A technical advantage of the system 200 includes offloading performance of the image-based cognitive analysis from the device 102 (e.g., XR glasses) to the device 202 (e.g., a companion device). Hence, the device 102 can be a relatively light-weight device, with the device 202 having more resources (e.g., more computing resources).

Another technical advantage of the system 200 includes improved accessibility to higher priority encoder output data 128 for image-based analysis. For example, the encoder output data 128 that has higher priority is retained longer for cognitive analysis. Additionally, lower priority encoder output data 128 can be removed to make space for more encoder output data 128.

In some examples, based on an output of the vision encoder 180, the image-based cognitive analyzer 146, a neural network, a machine-learning model, or a combination thereof, one or more components of a device (e.g., the device 102, the device 202, or both) can perform various operations such as: i) controlling a machine such as a vehicle, a robot, an appliance, a mobile device, a camera; ii) controlling an actuator such as an electromechanical actuator, an electrohydraulic actuator, an electroactive polymer actuator; iii) controlling an active circuit component such as a voltage or current source, a transistor, an amplifier, an integrated circuit, a programmable device such as field-programmable gate array (FPGA), a display device; iii) providing a notification to a user, such as a visual, auditory or haptic notification or combination thereof, iv) launching, closing, pausing or suspending an application on a computer; iv) launching, closing, pausing or suspending playback of audio video (AV) media on a computer; or v) providing a control signal to initiate any of the above.

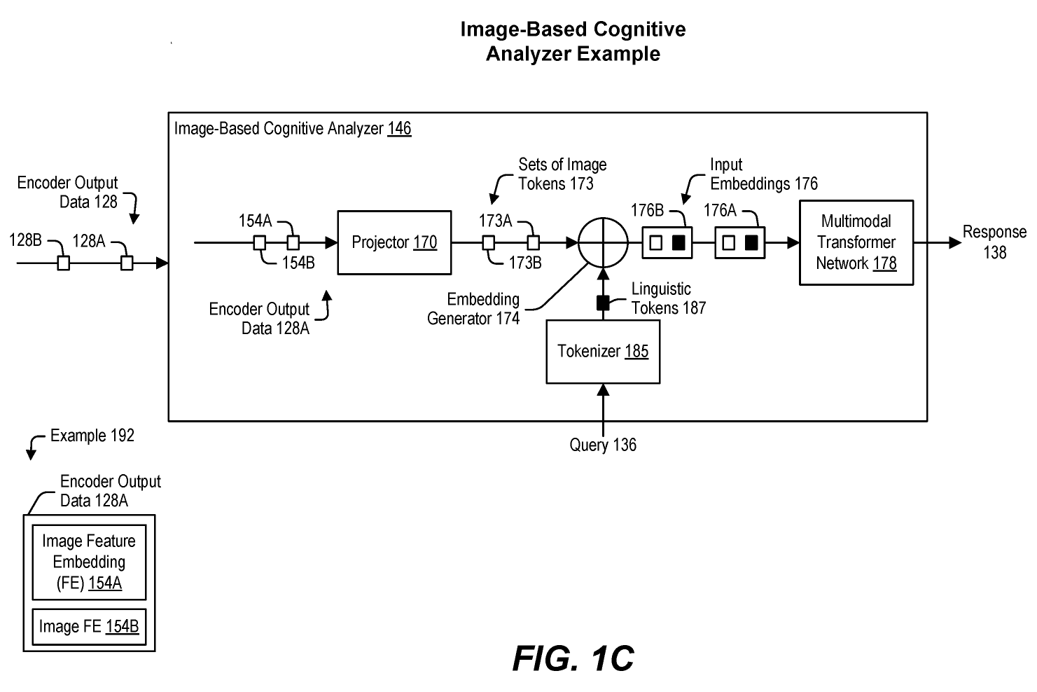

Referring to FIG. 3, a particular illustrative aspect of a system configured to perform priority-based retention of vision encoder output is disclosed and generally designated 300, in accordance with some examples of the present disclosure.

The one or more processors 190 include the vision encoder 180. The one or more processors 290 include the image-based cognitive analyzer 146 and the retention policy manager 184. The memory 232 is configured to store data used or generated by one or more components of the device 202. For example, the memory 232 is configured to store encoder output data 128, image analysis data 348, the query 136, the response 138, or a combination thereof. In a particular aspect, the image analysis data 348 is used to represent the sequence of the image frames 112 for image-based cognitive analysis. The vision encoder 180, the image-based cognitive analyzer 146, or both, are configured to generate (e.g., update) the priority data 165, as described with reference to FIG. 1A.

During operation, the vision encoder 180 processes the image frame 112A to generate the encoder output data 128A, and optionally generates the priority data 165A, as described with reference to FIG. 1A. Similarly, the vision encoder 180 processes one or more additional image frames of the sequence of image frames 112. For example, the vision encoder 180 processes the image frame 112B to generate the encoder output data 128B, and optionally generates the priority data 165B.

The device 102 transmits encoder output data 128 to the device 202. For example, the device 102 initiates transmission of the encoder output data 128A, the encoder output data 128B, or both, to the device 202. In some examples, the device 102 transmits the priority data 165 to the device 202. For example, the device 102 initiates transmission of the priority data 165A, the priority data 165B, or both.

The device 202 receives the encoder output data 128 and optionally the corresponding priority data 165 from the device 102. For example, the device 202 receives the encoder output data 128A, the encoder output data 128B, the priority data 165A, the priority data 165B, or a combination thereof. The device 202 adds the encoder output data 128 to the image analysis data 348 stored in the memory 232. In some aspects, the device 202, in response to receiving the priority data 165, also adds the priority data 165 to the image analysis data 348 and designates the priority data 165 as associated with the encoder output data 128.

The image-based cognitive analyzer 146 generates, based on the encoder output data 128A, the encoder output data 128B, or both, a response 138 to the query 136, as described with reference to FIG. 1A. In some examples, the image-based cognitive analyzer 146 generates (e.g., updates) the priority data 165, as described with reference to FIG. 1A, and stores the priority data 165 in the image analysis data 348.

The retention policy manager 184 determines whether to remove encoder output data 128 from the image analysis data 348, as described with reference to FIG. 1A. For example, the retention policy manager 184 determines whether to remove the encoder output data 128A from the image analysis data 348. The retention policy manager 184, in response to determining that the encoder output data 128A is to be removed, sends the deletion command 130 to the memory 232 to remove the encoder output data 128A, the priority data 165A, or both.

A technical advantage of the system 300 includes offloading storage of the image analysis data and performance of the image-based cognitive analysis from the device 102 (e.g., XR glasses) to the device 202 (e.g., a companion device). Hence, the device 102 can be a relatively light-weight device, with the device 202 having more resources (e.g., more memory, more computing resources, or both).

Another technical advantage of the system 300 includes improved accessibility to higher priority encoder output data 128 for image-based analysis. For example, the encoder output data 128 that has higher priority is retained longer for cognitive analysis. Additionally, lower priority encoder output data 128 can be removed to make space for more encoder output data 128.

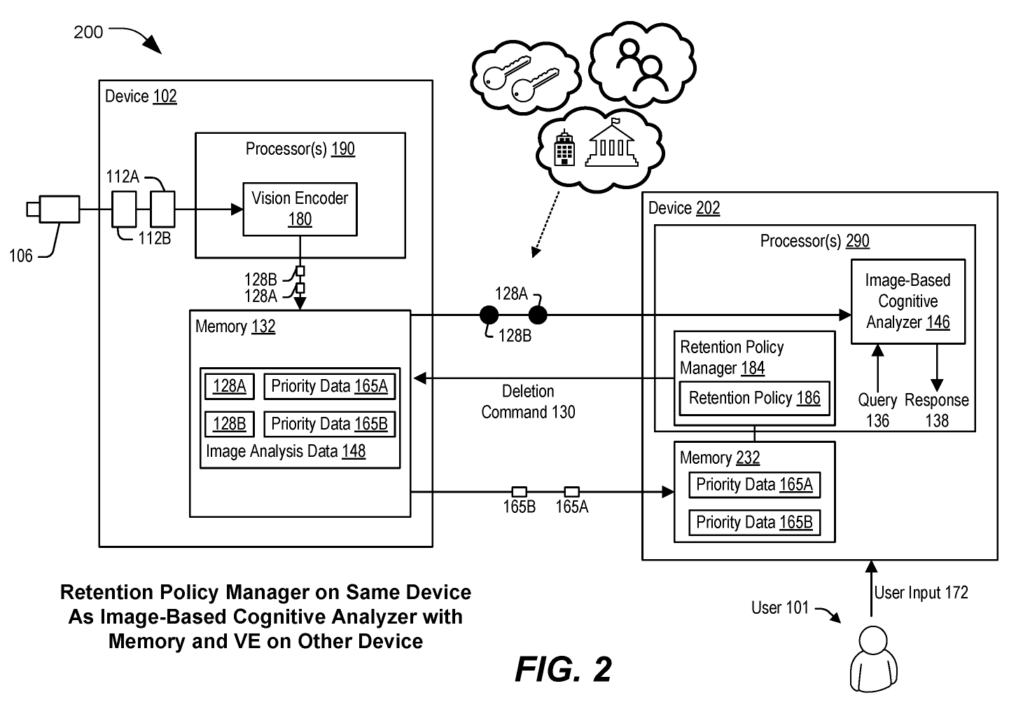

FIG. 4 depicts an implementation 400 of an integrated circuit 402 that includes one or more processors 490. In a particular aspect, the integrated circuit 402 corresponds to an implementation of the device 102, the device 202, or both.

The one or more processors 490 include one or more components 440, such as the image source 106, the vision encoder 180, the image-based cognitive analyzer 146, the retention policy manager 184, or a combination thereof. For example, the vision encoder 180 includes the multi-context local attention(s) 160, the downscaling layer(s) 162, the stage(s) 140, or a combination thereof, as described with reference to FIG. 1B. For example, the image-based cognitive analyzer 146 includes the projector 170, the tokenizer 185, the embedding generator 174, the multimodal transformer network 178, or a combination thereof, as described with reference to FIG. 1C.

The integrated circuit 402 also includes input circuitry 404, such as one or more bus interfaces, to enable input data 428 to be received for processing. In a particular aspect, the input data 428 includes data used by one or more of the components 440, as described herein. For example, the input data 428 includes the sequence of image frames 112, the encoder output data 128, the priority data 165, the retention policy 186, the image latent data 164, the image latent data 166, the image FEs 154, the query 136, the user input 172, the sets of image tokens 173, the linguistic tokens 187, the input embeddings 176, or a combination thereof.

The integrated circuit 402 also includes output circuitry 406, such as a bus interface, to enable sending of output data 430. In a particular aspect, the output data 430 includes data generated by one or more of the components 440, as described herein. For example, the output data 430 includes the sequence of image frames 112, the encoder output data 128, the priority data 165, the image latent data 164, the image latent data 166, the image FEs 154, the sets of encoder output data 128, the response 138, the sets of image tokens 173, the linguistic tokens 187, the input embeddings 176, or a combination thereof.

The integrated circuit 402 enables implementation of priority-based retention of vision encoder output as a component in a system, such as a mobile phone or tablet as depicted in FIG. 5, a wearable electronic device as depicted in FIG. 6A, a mixed reality or augmented reality glasses device, as described with reference to FIG. 7A, a voice-controlled speaker system as depicted in FIG. 8A, a camera as depicted in FIG. 9A, a virtual reality, mixed reality, or augmented reality headset as depicted in FIG. 10A, or a vehicle as depicted in FIG. 11A or FIG. 12A.

FIG. 5 depicts an implementation 500 of a mobile device 502, such as a phone or tablet, as illustrative, non-limiting examples. In a particular aspect, the mobile device 502 corresponds to an implementation of the device 102, the device 202, or both.

The mobile device 502 includes a display screen 504, and optionally the image source 106. The one or more components 440 of the processor(s) 490 are integrated in the mobile device 502 and are illustrated using dashed lines to indicate internal components that are not generally visible to a user of the mobile device 502. In a particular example, the image-based cognitive analyzer 146 detects the query 136, which is then processed to perform one or more operations at the mobile device 502, such as to launch a graphical user interface or otherwise display the response 138 at the display screen 504 (e.g., via an integrated “smart assistant” application).

The mobile device 502 performs one or more operations described with reference to the device 102, the device 202, or both, of FIGS. 1A-3. For example, in some aspects, the mobile device 502 obtains the image frames 112 from the image source 106 and generates the sets of encoder output data 128, as described with reference to the device 102 of FIG. 1A. In some aspects, the mobile device 502 stores encoder output data 128 in the image analysis data 148 stored in a memory (e.g., the memory 132) of the mobile device 502, as described with reference to FIGS. 1A and 2. The mobile device 502, responsive to receiving the query 136, uses the image-based cognitive analyzer 146 to generate the response 138 and outputs the response 138, as described with reference to the device 102 of FIG. 1A.

In some aspects, the mobile device 502 obtains the image frames 112 from the image source 106, generates the sets of encoder output data 128, and sends the sets of encoder output data 128 to another device, as described with reference to the device 102 of FIGS. 2-3. In some examples, the mobile device 502 adds the sets of encoder output data 128 to the image analysis data 148 stored in a memory (e.g., the memory 132) of the mobile device 502, as described with reference to FIG. 2. In some examples, the mobile device 502 adds the sets of encoder output data 128 to the image analysis data 348 stored in a memory (e.g., the memory 232) of the other device, as described with reference to FIG. 3.

In some examples, the mobile device 502 receives the query 136 and provides the query 136 to the other device. The other device uses the image-based cognitive analyzer 146 to generate the response 138, as described with reference to the device 202 of FIGS. 2-3. The mobile device 502 receives the response 138 from the other device and outputs the response 138. In some examples, the other device receives the query 136, uses the image-based cognitive analyzer 146 to generate the response 138, and outputs the response 138, as described with reference to the device 202 of FIGS. 2-3.

In some aspects, the mobile device 502 obtains the sets of encoder output data 128 from a second device (e.g., XR glasses), uses the image-based cognitive analyzer 146 to perform the cognitive analysis to generate the response 138, and outputs the response 138, as described with reference to the device 202 of FIGS. 2-3. In some examples, the mobile device 502 performs priority-based retention of the encoder output data 128, as described with reference to the retention policy manager 184 of FIGS. 1A-3.

FIG. 6A depicts an implementation 600 of a wearable electronic device 602, illustrated as a “smart watch.” In a particular aspect, the wearable electronic device 602 corresponds to an implementation of the device 102, the device 202, or both.

The one or more components 440, and optionally the image source 106, are integrated into the wearable electronic device 602. The wearable electronic device 602 performs one or more operations described with reference to the device 102, the device 202, or both, of FIGS. 1A-3. For example, the component(s) 440 operate to obtain the image frames 112, the sets of encoder output data 128, the priority data 165, the query 136, the response 138, or a combination thereof, which are then processed to perform one or more operations at the wearable electronic device 602, such as to launch a graphical user interface or otherwise display other information associated with the image frames 112, the sets of encoder output data 128, the priority data 165, the query 136, the response 138, or a combination thereof at a display screen 604 of the wearable electronic device 602.

In some aspects, the wearable electronic device 602 may include a display screen that is configured to display a notification based on obtaining the image frames 112, the sets of encoder output data 128, the priority data 165, the query 136, the response 138, or a combination thereof. In a particular example, the wearable electronic device 602 includes a haptic device that provides a haptic notification (e.g., vibrates) in response to obtaining the image frames 112, the sets of encoder output data 128, the priority data 165, the query 136, the response 138, or a combination thereof. For example, the haptic notification can cause a user to look at the wearable electronic device 602 to see a displayed notification indicating detection of the image frames 112, the sets of encoder output data 128, the priority data 165, the query 136, the response 138, or a combination thereof. The wearable electronic device 602 can thus alert a user with a hearing impairment or a user wearing a headset that the image frames 112, the sets of encoder output data 128, the priority data 165, the query 136, the response 138, or a combination thereof, are detected.

In some examples, the wearable electronic device 602 adds generated encoder output data 128 to the image analysis data 148 stored at a memory (e.g., the memory 132) of the wearable electronic device 602, as described with reference to FIGS. 1A-2, adds the encoder output data 128 to the image analysis data 348 stored at a memory (e.g., the memory 232) of another device, as described with reference to FIG. 3, or both. In some examples, the wearable electronic device 602 performs priority-based retention of the encoder output data 128, as described with reference to the retention policy manager 184 of FIGS. 1A-3.

FIG. 6B depicts an example 650 of the mobile device 502 and the wearable electronic device 602. The wearable electronic device 602 is configured to process an image frame 112 to generate encoder output data 128 and transmit the encoder output data 128 to the mobile device 502, and the mobile device 502 is configured to perform priority-based retention of the encoder output data 128, as described with reference to FIGS. 2-3. In some examples, an image frame 112 can depict sensitive information, people, homes, offices, etc., and transmitting the encoder output data 128 instead of the image frames 112 enhances security.

It should be understood that the mobile device 502 is provided as an illustrative example of a recipient device that receives the encoder output data 128; in other examples various types of devices can be recipients of encoder output data 128. In some examples, the mobile device 502 can transmit the encoder output data 128 to various other devices.

FIG. 7A depicts an implementation 700 of a portable electronic device that corresponds to augmented reality or mixed reality glasses 702. In a particular aspect, the glasses 702 correspond to an implementation of the device 102, the device 202, or both.

The glasses 702 include a holographic projection unit 704 configured to project visual data onto a surface of a lens 706 or to reflect the visual data off of a surface of the lens 706 and onto the wearer’s retina. The one or more components 440 and, optionally the image source 106, are integrated into the glasses 702. The glasses 702 perform one or more operations described with reference to the device 102, the device 202, or both, of FIGS. 1A-3. For example, the component(s) 440 may function to obtain the image frames 112, the sets of encoder output data 128, the priority data 165, the query 136, the response 138, or a combination thereof, as described with reference to FIGS. 1A-3.

In a particular example, the holographic projection unit 704 is configured to display a notification based on obtaining the image frames 112, the sets of encoder output data 128, the priority data 165, the query 136, the response 138, or a combination thereof. For example, the notification can be superimposed on the user’s field of view at a particular position that coincides with a location related to an answer indicated in the response 138. In some examples, the glasses 702 add generated encoder output data 128 to the image analysis data 148 stored at a memory (e.g., the memory 132) of the glasses 702, as described with reference to FIGS. 1A-2, add encoder output data 128 to the image analysis data 348 stored at a memory (e.g., the memory 232) of another device, as described with reference to FIG. 3, or both. In some examples, the glasses 702 perform priority-based retention of the encoder output data 128, as described with reference to the retention policy manager 184 of FIGS. 1A-3.

FIG. 7B depicts an example 750 of the mobile device 502 and the glasses 702. The glasses 702 are configured to process an image frame 112 to generate encoder output data 128 and transmit the encoder output data 128 to the mobile device 502, and the mobile device 502 is configured to perform priority-based retention of the encoder output data 128, as described with reference to FIGS. 2-3. In some examples, an image frame 112 can depict sensitive information, people, homes, offices, etc., and transmitting the encoder output data 128 instead of the image frames 112 enhances security.

FIG. 8A is an implementation 800 of a wireless speaker and voice activated device 802. In a particular aspect, the wireless speaker and voice activated device 802 corresponds to an implementation of the device 102, the device 202, or both.

The wireless speaker and voice activated device 802 can have wireless network connectivity and is configured to execute an assistant operation. The one or more components 440 and, optionally the image source 106, are integrated into the wireless speaker and voice activated device 802. The wireless speaker and voice activated device 802 also includes a speaker 804.

The wireless speaker and voice activated device 802 performs one or more operations described with reference to the device 102, the device 202, or both, of FIGS. 1A-3. For example, the component(s) 440 may function to obtain the image frames 112, the sets of encoder output data 128, the priority data 165, the query 136, the response 138, or a combination thereof, as described with reference to FIGS. 1A-3.

During operation, in response to receiving a verbal command, the wireless speaker and voice activated device 802 can execute assistant operations, such as via execution of a voice activation system (e.g., an integrated assistant application). The assistant operations can include adjusting a temperature, playing music, turning on lights, etc. For example, the assistant operations are performed responsive to receiving a command after a keyword or key phrase (e.g., “hello assistant”). In an example, the assistant operations include generating the response 138 to the query 136, as described with reference to the device 102, the device 202, or both, of FIGS. 1A-3. In some examples, the wireless speaker and voice activated device 802 adds generated encoder output data 128 to the image analysis data 148 stored at a memory (e.g., the memory 132) of the wireless speaker and voice activated device 802, as described with reference to FIGS. 1A-2, adds encoder output data 128 to the image analysis data 348 stored at a memory (e.g., the memory 232) of another device, as described with reference to FIG. 3, or both. In some examples, the wireless speaker and voice activated device 802 performs priority-based retention of the encoder output data 128, as described with reference to the retention policy manager 184 of FIGS. 1A-3.

FIG. 8B depicts an example 850 of the mobile device 502 and the wireless speaker and voice activated device 802. The wireless speaker and voice activated device 802 is configured to process an image frame 112 to generate encoder output data 128 and transmit the encoder output data 128 to the mobile device 502, and the mobile device 502 is configured to perform priority-based retention of the encoder output data 128, as described with reference to FIGS. 2-3. In some examples, an image frame 112 can depict sensitive information, people, homes, offices, etc., and transmitting the encoder output data 128 instead of the image frames 112 enhances security.

FIG. 9A depicts an implementation 900 of a portable electronic device that corresponds to a camera device 902. In a particular aspect, the camera device 902 corresponds to an implementation of the device 102, the device 202, or both.

The one or more components 440 and, optionally the image source 106, are included in the camera device 902. The camera device 902 performs one or more operations described with reference to the device 102, the device 202, or both, of FIGS. 1A-3. For example, the component(s) 440 may function to obtain the image frames 112, the sets of encoder output data 128, the priority data 165, the query 136, the response 138, or a combination thereof, as described with reference to FIGS. 1A-3.

During operation, in response to receiving a verbal command, the camera device 902 can execute operations responsive to spoken user commands, such as to adjust image or video capture settings, image or video playback settings, or image or video capture instructions, as illustrative examples. In an example, the camera device 902 generates the response 138 to the query 136, as described with reference to the device 102, the device 202, or both, of FIGS. 1A-3. In some examples, the camera device 902 adds generated encoder output data 128 to the image analysis data 148 stored in a memory (e.g., the memory 132) of the camera device 902, as described with reference to FIGS. 1A-2, adds the encoder output data 128 to the image analysis data 348 stored in a memory (e.g., the memory 232) of another device, as described with reference to FIG. 3, or both. In some examples, the camera device 902 performs priority-based retention of the encoder output data 128, as described with reference to the retention policy manager 184 of FIGS. 1A-3.

FIG. 9B depicts an example 950 of the mobile device 502 and the camera device 902. The camera device 902 is configured to process an image frame 112 to generate encoder output data 128 and transmit the encoder output data 128 to the mobile device 502, and the mobile device 502 is configured to perform priority-based retention of the encoder output data 128, as described with reference to FIGS. 2-3. In some examples, an image frame 112 can depict sensitive information, people, homes, offices, etc., and transmitting the encoder output data 128 instead of the image frames 112 enhances security.

FIG. 10A depicts an implementation 1000 of a portable electronic device that corresponds to a virtual reality, mixed reality, or augmented reality headset 1002. In a particular aspect, the headset 1002 corresponds to an implementation of the device 102, the device 202, or both.

The one or more components 440 and, optionally the image source 106, are included in the headset 1002. The headset 1002 performs one or more operations described with reference to the device 102, the device 202, or both, of FIGS. 1A-3. For example, the component(s) 440 may function to obtain the image frames 112, the sets of encoder output data 128, the priority data 165, the query 136, the response 138, or a combination thereof, as described with reference to FIGS. 1A-3.

In some aspects, the headset 1002 obtains the sequence of image frames 112 from the image source 106, generates the sets of encoder output data 128, and sends the sets of encoder output data 128 to another device (e.g., the mobile device 502 of FIG. 10), as described with reference to the device 102 of FIGS. 2-3. The other device uses the image-based cognitive analyzer 146 to generate the response 138, as described with reference to the device 202 of FIGS. 2-3. The headset 1002, the other device, or both, output the response 138.

In some examples, the headset 1002 adds generated encoder output data 128 to the image analysis data 148 stored in a memory (e.g., the memory 132) of the headset 1002, as described with reference to FIGS. 1A-2, adds encoder output data 128 to the image analysis data 348 stored in a memory (e.g., the memory 232) of another device, as described with reference to FIG. 3, or both. In some examples, the headset 1002 performs priority-based retention of the encoder output data 128, as described with reference to the retention policy manager 184 of FIGS. 1A-3.

In an example, a visual interface device is positioned in front of the user's eyes to enable display of augmented reality, mixed reality, or virtual reality images or scenes to the user while the headset 1002 is worn. In a particular example, the visual interface device is configured to display a notification indicating that image frames 112, the sets of encoder output data 128, the priority data 165, the query 136, the response 138, or a combination thereof, are detected. In some examples, the visual interface is configured to display the response 138.

FIG. 10B depicts an example 1050 of the mobile device 502 and the headset 1002. The headset 1002 is configured to process an image frame 112 to generate encoder output data 128 and transmit the encoder output data 128 to the mobile device 502, and the mobile device 502 is configured to perform priority-based retention of the encoder output data 128, as described with reference to FIGS. 2-3. In some examples, an image frame 112 can depict sensitive information, people, homes, offices, etc., and transmitting the encoder output data 128 instead of the image frames 112 enhances security.

FIG. 11A depicts an implementation 1100 of a vehicle 1102, illustrated as a manned or unmanned aerial device (e.g., a package delivery drone). In a particular aspect, the device 102, the device 202, or both, correspond to or are integrated into the vehicle 1102.

The one or more components 440 and, optionally the image source 106, are included in the vehicle 1102. The vehicle 1102 performs one or more operations described with reference to the device 102, the device 202, or both, of FIGS. 1A-3. For example, the component(s) 440 may function to obtain the image frames 112, the sets of encoder output data 128, the priority data 165, the query 136, the response 138, or a combination thereof, as described with reference to FIGS. 1A-3.

In an example, the vehicle 1102 receives a query 136, such as for installation instructions, of a delivered package depicted in the sequence of image frames 112. The vehicle 1102 processes the image frames 112 to generate the sets of encoder output data 128. In some examples, the vehicle 1102 uses the image-based cognitive analyzer 146 to process the sets of encoder output data 128 to generate the response 138 to the query 136, as described with reference to the device 102 of FIG. 1A. In some examples, the vehicle 1102 sends the sets of encoder output data 128 to another device, as described with reference to the device 102 of FIGS. 2-3. The other device uses the image-based cognitive analyzer 146 to process the sets of encoder output data 128 to generate the response 138, as described with reference to the device 202 of FIGS. 2-3. In a particular aspect, the vehicle 1102 outputs the response 138.

In some examples, the vehicle 1102 adds generated encoder output data 128 to the image analysis data 148 stored at a memory (e.g., the memory 132) of the vehicle 1102, as described with reference to FIGS. 1A-2, adds encoder output data 128 to the image analysis data 348 stored in a memory (e.g., the memory 232) of another device, as described with reference to FIG. 3, or both. In some examples, the vehicle 1102 performs priority-based retention of the encoder output data 128, as described with reference to the retention policy manager 184 of FIGS. 1A-3.

FIG. 11B depicts an example 1150 of the mobile device 502 and the vehicle 1102. The vehicle 1102 is configured to process an image frame 112 to generate encoder output data 128 and transmit the encoder output data 128 to the mobile device 502, and the mobile device 502 is configured to perform priority-based retention of the encoder output data 128, as described with reference to FIGS. 2-3. In some examples, an image frame 112 can depict sensitive information, people, homes, offices, etc., and transmitting the encoder output data 128 instead of the image frames 112 enhances security.

FIG. 12A depicts another implementation 1200 of a vehicle 1202, illustrated as a car. In a particular aspect, the vehicle 1202 corresponds to an implementation of the device 102, the device 202, or both. In a particular aspect, the device 102, the device 202, or both, correspond to or are integrated into the vehicle 1202.

The one or more components 440 and, optionally the image source 106, are included in the vehicle 1202. In some aspects, the vehicle 1202 includes a microphone 1222. The vehicle 1202 performs one or more operations described with reference to the device 102, the device 202, or both, of FIGS. 1A-3. For example, the component(s) 440 may function to obtain the image frames 112, the sets of encoder output data 128, the priority data 165, the query 136, the response 138, or a combination thereof, as described with reference to FIGS. 1A-3.

In some aspects, the query 136 may be detected based on audio signals received from the microphone 1222 of the vehicle 1202. In some implementations, query detection can be performed based on an audio signal received from interior microphones (e.g., the microphone 1222), such as for a voice query from an authorized passenger. In some implementations, query detection can be performed based on an audio signal received from external microphones (e.g., the microphone 1222), such as an authorized user of the vehicle. In a particular implementation, in response to receiving a verbal command, a voice activation system initiates one or more operations of the vehicle 1202 based on one or more keywords (e.g., “unlock,” “start engine,” “play music,” “display weather forecast,” or another voice command) detected in an audio signal, such as by providing feedback or information via a display 1220 or one or more speakers (e.g., a speaker 1210).

In some aspects, the vehicle 1202 processes image frames 112 to generate the sets of encoder output data 128. In some examples, the vehicle 1202 uses the image-based cognitive analyzer 146 to process the sets of encoder output data 128 to generate the response 138 to the query 136, as described with reference to the device 102 of FIG. 1A. In some examples, the vehicle 1202 sends the sets of encoder output data 128 to another device, as described with reference to the device 102 of FIGS. 2-3. The other device uses the image-based cognitive analyzer 146 to process the sets of encoder output data 128 to generate the response 138, as described with reference to the device 202 of FIGS. 2-3. In a particular aspect, the vehicle 1202 outputs the response 138 via the display 1220, the speaker 1210, or both.

In some examples, the vehicle 1202 adds generated encoder output data 128 to the image analysis data 148 stored in a memory (e.g., the memory 132) of the vehicle 1202, as described with reference to FIGS. 1A-2, adds encoder output data 128 to the image analysis data 348 stored in a memory (e.g., the memory 232) of another device, as described with reference to FIG. 3, or both. In some examples, the vehicle 1202 performs priority-based retention of the encoder output data 128, as described with reference to the retention policy manager 184 of FIGS. 1A-3.

FIG. 12B depicts an example 1250 of the mobile device 502 and the vehicle 1202. The vehicle 1202 is configured to process an image frame 112 to generate encoder output data 128 and transmit the encoder output data 128 to the mobile device 502, and the mobile device 502 is configured to perform priority-based retention of the encoder output data 128, as described with reference to FIGS. 2-3. In some examples, an image frame 112 can depict sensitive information, people, homes, offices, etc., and transmitting the encoder output data 128 instead of the image frames 112 enhances security.

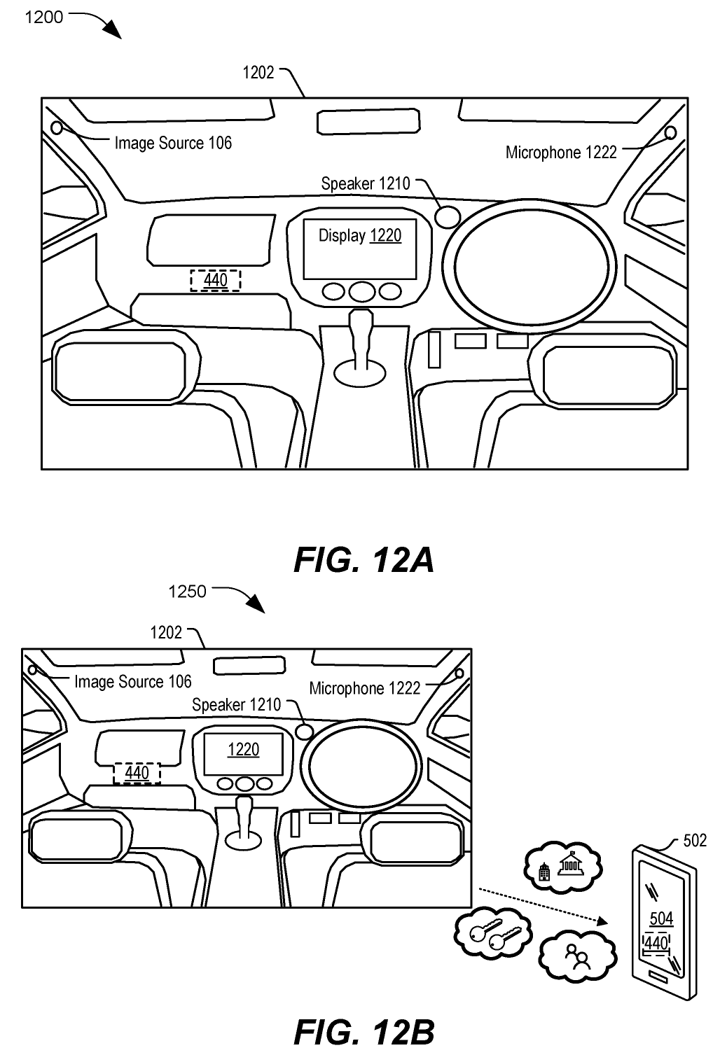

Referring to FIG. 13, a particular implementation of a method 1300 of performing priority-based retention of vision encoder output is shown. In a particular aspect, one or more operations of the method 1300 are performed by at least one of the retention policy manager 184, the one or more processors 190, the device 102, the system 100 of FIG. 1A, the one or more components 440, the integrated circuit 402 of FIG. 4, or a combination thereof.

The method 1300 includes, at 1302, using a vision encoder to process an image frame of a sequence of image frames to generate encoder output data. For example, the vision encoder 180 processes the image frame 112A of the sequence of image frames 112 to generate encoder output data 128A, as described with reference to FIG. 1A.

The method 1300 includes, at 1304, adding the encoder output data to image analysis data used to represent the sequence of image frames for image-based cognitive analysis. For example, the vision encoder 180 adds the encoder output data 128A to the image analysis data 148 used to represent the sequence of image frames 112 for image-based cognitive analysis, as described with reference to FIG. 1A.

The method 1300 includes, at 1306, based on a retention policy and a retention priority of the encoder output data, determining whether to remove the encoder output data from the image analysis data. For example, the retention policy manager 184, based on the retention policy 186 and a retention priority (e.g., indicated by the priority data 165A) of the encoder output data 128A, determines whether to remove the encoder output data 128A from the image analysis data 148, as described with reference to FIG. 1A.

A technical advantage of the method 1300 includes improved accessibility to higher priority encoder output data 128 for image-based analysis. For example, the encoder output data 128 that has higher priority is retained longer for cognitive analysis. Additionally, lower priority encoder output data 128 can be removed to make space for more encoder output data 128.

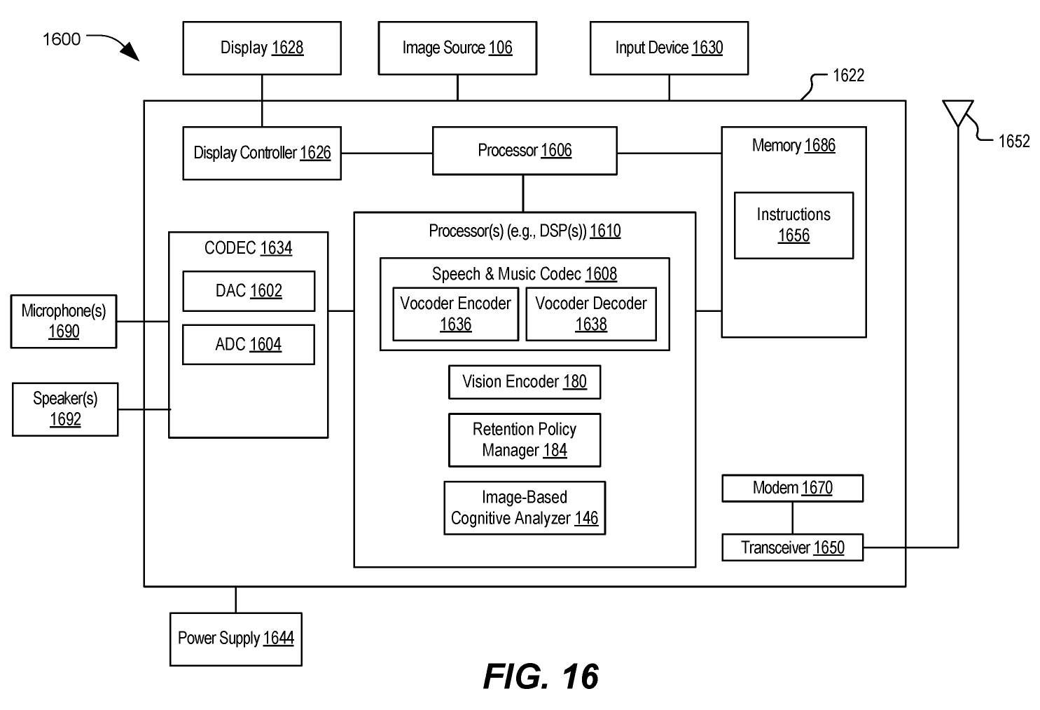

The method 1300 of FIG. 13 may be implemented by a FPGA device, an application-specific integrated circuit (ASIC), a processing unit such as a central processing unit (CPU), a digital signal processor (DSP), a controller, another hardware device, firmware device, or any combination thereof. As an example, the method 1300 of FIG. 13 may be performed by a processor that executes instructions, such as described with reference to FIG. 16.

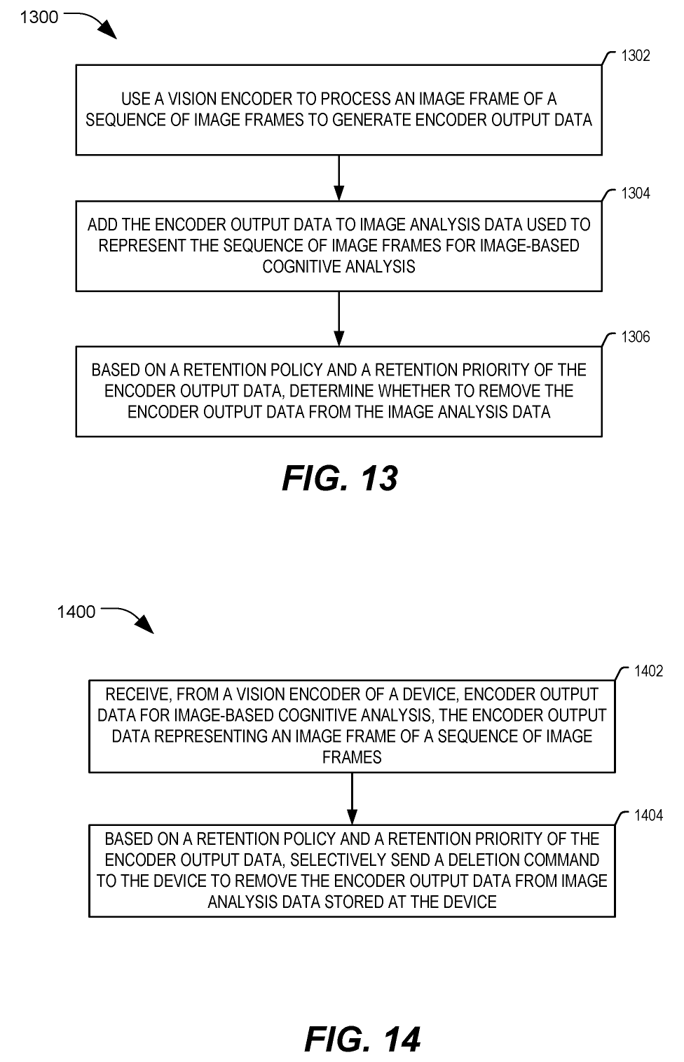

Referring to FIG. 14, a particular implementation of a method 1400 of performing priority-based retention of vision encoder output is shown. In a particular aspect, one or more operations of the method 1400 are performed by at least one of the retention policy manager 184 of FIG. 1A, the one or more processors 290, the device 202, the system 200 of FIG. 2, the one or more components 440, the integrated circuit 402 of FIG. 4, or a combination thereof.

The method 1400 includes, at 1402, receiving, from a vision encoder of a device, encoder output data for image-based cognitive analysis, the encoder output data representing an image frame of a sequence of image frames. For example, the device 202 receives, from the vision encoder 180 of the device 102, the encoder output data 128A for image-based cognitive analysis, as described with reference to FIG. 2. The encoder output data 128A represents the image frame 112A of the sequence of the image frames 112.

The method 1400 also includes, at 1404, based on a retention policy and a retention priority of the encoder output data, selectively sending a deletion command to the device to remove the encoder output data from image analysis data stored at the device. For example, the retention policy manager 184, based on the retention policy 186 and a retention priority (e.g., indicated by the priority data 165A) of the encoder output data 128A, selectively sends the deletion command 130 to the device 102 to remove the encoder output data 128 from the image analysis data 148 stored at the device 102. To illustrate, the retention policy manager 184, in response to determining that the priority of the encoder output data 128A is lower than a priority threshold, sends the deletion command 130 to the device 102.

A technical advantage of the method 1400 includes improved accessibility to higher priority encoder output data 128 for image-based analysis. For example, the encoder output data 128 that has higher priority is retained longer for cognitive analysis. Additionally, lower priority encoder output data 128 can be removed to make space for more encoder output data 128.

The method 1400 of FIG. 14 may be implemented by a FPGA device, an ASIC, a processing unit such as a CPU, a DSP, a controller, another hardware device, firmware device, or any combination thereof. As an example, the method 1400 of FIG. 14 may be performed by a processor that executes instructions, such as described with reference to FIG. 16.

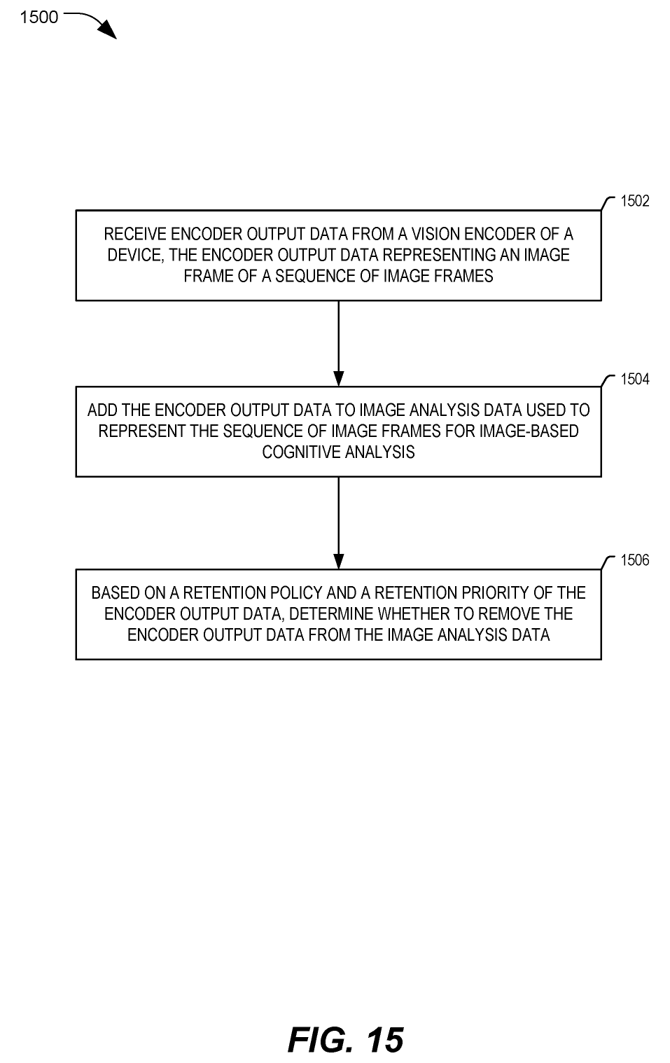

Referring to FIG. 15, a particular implementation of a method 1500 of performing priority-based retention of vision encoder output is shown. In a particular aspect, one or more operations of the method 1500 are performed by at least one of the retention policy manager 184 of FIG. 1A, the one or more processors 290, the device 202, the system 200 of FIG. 2, the system 300 of FIG. 3, the one or more components 440, the integrated circuit 402 of FIG. 4, or a combination thereof.

The method 1500 includes, at 1502, receiving encoder output data from a vision encoder of a device, the encoder output data representing an image frame of a sequence of image frames. For example, the device 202 receives the encoder output data 128A from the vision encoder 180 of the device 102. The encoder output data 128A represents the image frame 112A of the sequence of image frames 112, as described with reference to FIGS. 2-3.

The method 1500 also includes, at 1504, adding the encoder output data to image analysis data used to represent the sequence of image frames for image-based cognitive analysis. For example, the device 202 adds the encoder output data 128A to the image analysis data 348 used to represent the sequence of image frames 112 for image-based cognitive analysis.

The method 1500 also includes, at 1506, based on a retention policy and a retention priority of the encoder output data, determining whether to remove the encoder output data from the image analysis data. For example, the retention policy manager 184, based on the retention policy 186 and a retention priority (e.g., indicated by the priority data 165A) of the encoder output data 128A, determines whether to remove the encoder output data 128A from the image analysis data 348, as described with reference to FIG. 3.

A technical advantage of the method 1500 includes improved accessibility to higher priority encoder output data 128 for image-based analysis. For example, the encoder output data 128 that has higher priority is retained longer for cognitive analysis. Additionally, lower priority encoder output data 128 can be removed to make space for more encoder output data 128.

The method 1500 of FIG. 15 may be implemented by a FPGA device, an ASIC, a processing unit such as a CPU, a DSP, a controller, another hardware device, firmware device, or any combination thereof. As an example, the method 1500 of FIG. 15 may be performed by a processor that executes instructions, such as described with reference to FIG. 16.

Referring to FIG. 16, a block diagram of a particular illustrative implementation of a device is depicted and generally designated 1600. In various implementations, the device 1600 may have more or fewer components than illustrated in FIG. 16. In an illustrative implementation, the device 1600 may correspond to the device 102, the device 202, or both. In an illustrative implementation, the device 1600 may perform one or more operations described with reference to FIGS. 1A-15.

In a particular implementation, the device 1600 includes a processor 1606 (e.g., a CPU). The device 1600 may include one or more additional processors 1610 (e.g., one or more DSPs). In a particular aspect, the one or more processors 190 of FIG. 1A, the one or more processors 290 of FIG. 2, the one or more processor(s) 490 of FIG. 4, or a combination thereof, correspond to the processor 1606, the processors 1610, or a combination thereof. The processors 1610 may include a speech and music coder-decoder (CODEC) 1608 that includes a voice coder (“vocoder”) encoder 1636, a vocoder decoder 1638, or both. The processors 1610 include the vision encoder 180, the image-based cognitive analyzer 146, the retention policy manager 184, or a combination thereof. Optionally, in some embodiments, the processors 1610 include the image source 106.

The device 1600 may include a memory 1686 and a CODEC 1634. The memory 1686 may include instructions 1656, that are executable by the one or more additional processors 1610 (or the processor 1606) to implement the functionality described with reference to the one or more components 440. The one or more components 440 include the image-based cognitive analyzer 146, the vision encoder 180, the retention policy manager 184, the image source 106, or a combination thereof, as described with reference to FIG. 4. The device 1600 may include a modem 1670 coupled, via a transceiver 1650, to an antenna 1652.

In a particular aspect, the modem 1670 is configured to transmit one or more sets of encoder output data 128, receive one or more sets of encoder output data 128, or both. For example, the modem 1670 may transmit one or more first sets of encoder output data 128 to one device and receive one or more second sets of encoder output data 128 from another device. Optionally, in some embodiments, the modem 1670 is configured to receive the sequence of image frames 112 from the image source 106. Optionally, in some embodiments, the modem 1670 is configured to transmit priority data 165, receive priority data 165, or both.

The device 1600 may include a display 1628 coupled to a display controller 1626. One or more speakers 1692, one or more microphones 1690, or a combination thereof may be coupled to the CODEC 1634. The CODEC 1634 may include a digital-to-analog converter (DAC) 1602, an analog-to-digital converter (ADC) 1604, or both. In a particular implementation, the CODEC 1634 may receive analog signals from the one or more microphones 1690, convert the analog signals to digital signals using the analog-to-digital converter 1604, and provide the digital signals to the speech and music codec 1608. The speech and music codec 1608 may process the digital signals. In a particular implementation, the speech and music codec 1608 may provide digital signals to the CODEC 1634. The CODEC 1634 may convert the digital signals to analog signals using the digital-to-analog converter 1602 and may provide the analog signals to the one or more speakers 1692.

In a particular implementation, the device 1600 may be included in a system-in-package or system-on-chip device 1622. In a particular implementation, the memory 1686, the processor 1606, the processors 1610, the display controller 1626, the CODEC 1634, and the modem 1670 are included in the system-in-package or system-on-chip device 1622. In a particular implementation, an input device 1630, a power supply 1644, and optionally the image source 106, are coupled to the system-in-package or the system-on-chip device 1622. Moreover, in a particular implementation, as illustrated in FIG. 16, the display 1628, the input device 1630, the one or more speakers 1692, the one or more microphones 1690, the antenna 1652, the power supply 1644, and optionally the image source 106, are external to the system-in-package or the system-on-chip device 1622. In a particular implementation, each of the display 1628, the input device 1630, the one or more speakers 1692, the one or more microphones 1690, the antenna 1652, the power supply 1644, and optionally the image source 106 may be coupled to a component of the system-in-package or the system-on-chip device 1622, such as an interface or a controller.

The device 1600 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an extended reality headset, an aerial vehicle, a home automation system, a voice-activated device, a wireless speaker and voice activated device, a portable electronic device, a car, a computing device, a communication device, an internet-of-things (IoT) device, a virtual reality (VR) device, an extended reality (XR) device, a base station, a mobile device, or any combination thereof.

In conjunction with the described implementations, an apparatus includes means for using a vision encoder to process an image frame of a sequence of image frames to generate encoder output data. For example, the means for using a vision encoder can correspond to the vision encoder 180, the one or more processors 190, the device 102, the system 100 of FIG. 1A, the system 200 of FIG. 2, the system 300 of FIG. 3, the component(s) 440, the processor(s) 490, the integrated circuit 402 of FIG. 4, the processor 1606, the processor 1610, the device 1600, one or more other circuits or components configured to use a vision encoder, or any combination thereof.

The apparatus also includes means for adding the encoder output data to image analysis data used to represent the sequence of image frames for image-based cognitive analysis. For example, the means for adding the encoder output data can correspond to the vision encoder 180, the memory 132, the one or more processors 190, the device 102, the system 100 of FIG. 1A, the system 200 of FIG. 2, the memory 232, the system 300 of FIG. 3, the component(s) 440, the processor(s) 490, the integrated circuit 402 of FIG. 4, the processor 1606, the processor 1610, the memory 1686, the device 1600, one or more other circuits or components configured to add the encoder output data to image analysis data, or any combination thereof.

The apparatus also includes means for determining, based on a retention policy and a retention priority of the encoder output data, whether to remove the encoder output data from the image analysis data. For example, the means for determining can correspond to the retention policy manager 184, the one or more processors 190, the device 102, the system 100 of FIG. 1A, the system 200 of FIG. 2, the system 300 of FIG. 3, the component(s) 440, the processor(s) 490, the integrated circuit 402 of FIG. 4, the processor 1606, the processor 1610, the device 1600, one or more other circuits or components configured to determine whether to remove the encoder output data, or any combination thereof.

Also in conjunction with the described implementations, an apparatus includes means for receiving, from a vision encoder of a device, encoder output data for image-based cognitive analysis, the encoder output data representing an image frame of a sequence of image frames. For example, the means for receiving can correspond to the memory 232, the image-based cognitive analyzer 146, the one or more processors 290, the device 202, the system 200 of FIG. 2, the input circuitry 404, the component(s) 440, the processor(s) 490, the antenna 1652, the transceiver 1650, the modem 1670, the processor 1606, the processor 1610, the device 1600, one or more other circuits or components configured to receive encoder output data, or any combination thereof.

The apparatus also includes means for selectively sending, based on a retention policy and a retention priority of the encoder output data, a deletion command to the device to remove the encoder output data from image analysis data stored at the device. For example, the means for selectively sending the deletion command can correspond to the retention policy manager 184, the one or more processors 290, the device 202, the system 200 of FIG. 2, the output circuitry 406, the component(s) 440, the processor(s) 490, the antenna 1652, the transceiver 1650, the modem 1670, the processor 1606, the processor 1610, the device 1600, one or more other circuits or components configured to send a deletion command, or any combination thereof.

Also in conjunction with the described implementations, an apparatus includes means for receiving encoder output data from a vision encoder of a device, the encoder output data representing an image frame of a sequence of image frames. For example, the means for receiving can correspond to the memory 232, the image-based cognitive analyzer 146, the one or more processors 290, the device 202, the system 200 of FIG. 2, the system 300 of FIG. 3, the input circuitry 404, the component(s) 440, the processor(s) 490, the antenna 1652, the transceiver 1650, the modem 1670, the processor 1606, the processor 1610, the device 1600, one or more other circuits or components configured to receive encoder output data, or any combination thereof.

The apparatus also includes means for adding the encoder output data to image analysis data used to represent the sequence of image frames for image-based cognitive analysis. For example, the means for adding can correspond to the memory 232, the one or more processors 290, the device 202 of FIG. 2, the system 300 of FIG. 3, the input circuitry 404, the component(s) 440, the processor(s) 490, the processor 1606, the processor 1610, the device 1600, one or more other circuits or components configured to add encoder output data, or any combination thereof.

The apparatus also includes means for determining, based on a retention policy and a retention priority of the encoder output data, whether to remove the encoder output data from the image analysis data. For example, the means for determining can correspond to the retention policy manager 184 of FIG. 1A, the one or more processors 290, the device 202 of FIG. 2, the system 300 of FIG. 3, the component(s) 440, the processor(s) 490, the processor 1606, the processor 1610, the device 1600, one or more other circuits or components configured to determine whether to remove the encoder output data, or any combination thereof.

In some implementations, a non-transitory computer-readable medium (e.g., a computer-readable storage device, such as the memory 1686) includes instructions (e.g., the instructions 1656) that, when executed by one or more processors (e.g., the one or more processors 1610 or the processor 1606), cause the one or more processors to use a vision encoder (e.g., the vision encoder 180) to process an image frame (e.g., the image frame 112A) of a sequence of image frames (e.g., the image frames 112) to generate encoder output data (e.g., the encoder output data 128A). The instructions further cause the one or more processors to add the encoder output data to image analysis data (e.g., the image analysis data 148) used to represent the sequence of image frames for image-based cognitive analysis. The instructions further cause the one or more processors to, based on a retention policy (e.g., the retention policy 186) and a retention priority (e.g., indicated by the priority data 165A) of the encoder output data, determine whether to remove the encoder output data from the image analysis data.

In some implementations, a non-transitory computer-readable medium (e.g., a computer-readable storage device, such as the memory 1686) includes instructions (e.g., the instructions 1656) that, when executed by one or more processors (e.g., the one or more processors 1610 or the processor 1606), cause the one or more processors to receive, from a vision encoder (e.g., the vision encoder 180) of a device (e.g., the device 102), encoder output data (e.g., the encoder output data 128A) for image-based cognitive analysis, the encoder output data representing an image frame (e.g., the image frame 112A) of a sequence of image frames (e.g., the image frames 112). The instructions further cause the one or more processors to, based on a retention policy (e.g., the retention policy 186) and a retention priority (e.g., as indicated by the priority data 165A) of the encoder output data, selectively send a deletion command (e.g., the deletion command 130) to the device to remove the encoder output data from image analysis data (e.g., the image analysis data 148) stored at the device.

In some implementations, a non-transitory computer-readable medium (e.g., a computer-readable storage device, such as the memory 1686) includes instructions (e.g., the instructions 1656) that, when executed by one or more processors (e.g., the one or more processors 1610 or the processor 1606), cause the one or more processors to receive encoder output data (e.g., the encoder output data 128A) from a vision encoder (e.g., the vision encoder 180) of a device (e.g., the device 102), the encoder output data representing an image frame (e.g., the image frame 112A) of a sequence of image frames (e.g., the image frames 112). The instructions further cause the one or more processors to add the encoder output data to image analysis data (e.g., the image analysis data 248) used to represent the sequence of image frames for image-based cognitive analysis. The instructions further cause the one or more processors to, based on a retention policy (e.g., the retention policy 186) and a retention priority (e.g., as indicated by the priority data 165A) of the encoder output data, determine whether to remove the encoder output data from the image analysis data.

Particular aspects of the disclosure are described below in sets of interrelated Examples:

According to Example 1, a device includes a memory configured to store image analysis data; and one or more processors coupled to the memory and configured to use a vision encoder to process an image frame of a sequence of image frames to generate encoder output data; add the encoder output data to the image analysis data used to represent the sequence of image frames for image-based cognitive analysis; and based on a retention policy and a retention priority of the encoder output data, determine whether to remove the encoder output data from the image analysis data.

Example 2 includes the device of Example 1, wherein the one or more processors are configured to, based on a user input, update the retention priority of the encoder output data.

Example 3 includes the device of Example 1 or Example 2, wherein the one or more processors are configured to adjust, based on use of the encoder output data, the retention priority of the encoder output data.

Example 4 includes the device of any of Examples 1 to 3, wherein the one or more processors are configured to perform the image-based cognitive analysis.

Example 5 includes the device of any of Examples 1 to 4, wherein the one or more processors are configured to generate image tokens based on the encoder output data; generate linguistic tokens based on a query; and use a multimodal transformer network to perform the image-based cognitive analysis based on the image tokens and the linguistic tokens to generate a response.

Example 6 includes the device of any of Examples 1 to 5, wherein the one or more processors and the memory are integrated into a headset, a communication device, or both.

Example 7 includes the device of any of Examples 1 to 6, and further includes a modem coupled to the one or more processors and configured to receive the sequence of image frames.

Example 8 includes the device of any of Examples 1 to 7, and further includes a camera coupled to the one or more processors and configured to generate the sequence of image frames.

According to Example 9, a device includes a memory configured to store sets of encoder output data; and one or more processors coupled to the memory and configured to receive, from a vision encoder of a second device, encoder output data for image-based cognitive analysis, the encoder output data representing an image frame of a sequence of image frames; and based on a retention policy and a retention priority of the encoder output data, selectively send a deletion command to the second device to remove the encoder output data from image analysis data stored at the second device.

Example 10 includes the device of Example 9, wherein the one or more processors are configured to, based on a user input, update the retention priority of the encoder output data.

Example 11 includes the device of Example 9 or Example 10, wherein the one or more processors are configured to adjust, based on use of the encoder output data, the retention priority of the encoder output data.

Example 12 includes the device of any of Examples 9 to 11, wherein the one or more processors are configured to perform the image-based cognitive analysis.

Example 13 includes the device of any of Examples 9 to 12, wherein the one or more processors are configured to generate image tokens based on the encoder output data; generate linguistic tokens based on a query; and use a multimodal transformer network to perform the image-based cognitive analysis based on the image tokens and the linguistic tokens to generate a response.

Example 14 includes the device of any of Examples 9 to 13, wherein the one or more processors and the memory are integrated into a headset, a communication device, or both.

Example 15 includes the device of any of Examples 9 to 14, and further includes a modem coupled to the one or more processors and configured to receive the encoder output data from the second device.

Example 16 includes the device of any of Examples 9 to 15, and further includes a modem coupled to the one or more processors and configured to send the deletion command to the second device.

According to Example 17, a device includes a memory configured to store image analysis data; and one or more processors coupled to the memory and configured to receive encoder output data from a vision encoder of a second device, the encoder output data representing an image frame of a sequence of image frames; add the encoder output data to the image analysis data used to represent the sequence of image frames for image-based cognitive analysis; and based on a retention policy and a retention priority of the encoder output data, determine whether to remove the encoder output data from the image analysis data.

Example 18 includes the device of Example 17, wherein the one or more processors are configured to, based on a user input, update the retention priority of the encoder output data.

Example 19 includes the device of Example 17 or Example 18, wherein the one or more processors are configured to adjust, based on use of the encoder output data, the retention priority of the encoder output data.

Example 20 includes the device of any of Examples 17 to 19, wherein the one or more processors are configured to perform the image-based cognitive analysis.

Example 21 includes the device of any of Examples 17 to 20, wherein the one or more processors are configured to generate image tokens based on the encoder output data; generate linguistic tokens based on a query; and use a multimodal transformer network to perform the image-based cognitive analysis based on the image tokens and the linguistic tokens to generate a response.

Example 22 includes the device of any of Examples 17 to 21, wherein the one or more processors and the memory are integrated into a headset, a communication device, or both.

Example 23 includes the device of any of Examples 17 to 22, and further includes a modem coupled to the one or more processors and configured to receive the encoder output data.

According to Example 24, a method includes using a vision encoder to process an image frame of a sequence of image frames to generate encoder output data; adding the encoder output data to image analysis data used to represent the sequence of image frames for image-based cognitive analysis; and based on a retention policy and a retention priority of the encoder output data, determining whether to remove the encoder output data from the image analysis data.

Example 25 includes the method of Example 24, further comprising, based on a user input, updating the retention priority of the encoder output data.

Example 26 includes the method of Example 24 or Example 25, further comprising adjusting, based on use of the encoder output data, the retention priority of the encoder output data.

Example 27 includes the method of any of Examples 24 to 26, and further includes performing the image-based cognitive analysis.

Example 28 includes the method of any of Examples 24 to 27, further includes generating image tokens based on the encoder output data; generating linguistic tokens based on a query; and using a multimodal transformer network to perform the image-based cognitive analysis based on the image tokens and the linguistic tokens to generate a response.

Example 29 includes the method of any of Examples 24 to 28, wherein the vision encoder is integrated into a headset, a communication device, or both.

Example 30 includes the method of any of Examples 24 to 29, and further includes receiving, using a modem, the sequence of image frames.

Example 31 includes the method of any of Examples 24 to 30, and further includes generating, using a camera, the sequence of image frames.

According to Example 32, a method includes receiving, from a vision encoder of a device, encoder output data for image-based cognitive analysis, the encoder output data representing an image frame of a sequence of image frames; and based on a retention policy and a retention priority of the encoder output data, selectively sending a deletion command to the device to remove the encoder output data from image analysis data stored at the device.

Example 33 includes the method of Example 32, further comprising, based on a user input, updating the retention priority of the encoder output data.

Example 34 includes the method of Example 32 or Example 33, further comprising adjusting, based on use of the encoder output data, the retention priority of the encoder output data.

Example 35 includes the method of any of Examples 32 to 34, and further includes performing the image-based cognitive analysis.

Example 36 includes the method of any of Examples 32 to 35, further includes generating image tokens based on the encoder output data; generating linguistic tokens based on a query; and using a multimodal transformer network to perform the image-based cognitive analysis based on the image tokens and the linguistic tokens to generate a response.

Example 37 includes the method of any of Examples 32 to 36, and further includes receiving, using a modem, the encoder output data from the device.

Example 38 includes the method of any of Examples 32 to 37, and further includes sending, using a modem, the deletion command to the device.

According to Example 39, a method includes receiving encoder output data from a vision encoder of a device, the encoder output data representing an image frame of a sequence of image frames; adding the encoder output data to image analysis data used to represent the sequence of image frames for image-based cognitive analysis; and based on a retention policy and a retention priority of the encoder output data, determining whether to remove the encoder output data from the image analysis data.

Example 40 includes the method of Example 39, further comprising, based on a user input, updating the retention priority of the encoder output data.

Example 41 includes the method of Example 39 or Example 40, further comprising adjusting, based on use of the encoder output data, the retention priority of the encoder output data.

Example 42 includes the method of any of Examples 39 to 41 and further includes performing the image-based cognitive analysis.

Example 43 includes the method of any of Examples 39 to 42, further includes generating image tokens based on the encoder output data; generating linguistic tokens based on a query; and using a multimodal transformer network to perform the image-based cognitive analysis based on the image tokens and the linguistic tokens to generate a response.

Example 44 includes the method of any of Examples 39 to 43 and further includes receiving, using a modem, the encoder output data.

According to Example 45, a non-transitory computer-readable medium stores instructions that, when executed by one or more processors, cause the one or more processors to use a vision encoder to process an image frame of a sequence of image frames to generate encoder output data; add the encoder output data to image analysis data used to represent the sequence of image frames for image-based cognitive analysis; and based on a retention policy and a retention priority of the encoder output data, determine whether to remove the encoder output data from the image analysis data.

Example 46 includes the non-transitory computer-readable medium of Example 45, wherein the instructions, when executed by one or more processors, cause the one or more processors to, based on a user input, update the retention priority of the encoder output data.

Example 47 includes the non-transitory computer-readable medium of Example 45 or Example 46, wherein the instructions, when executed by one or more processors, cause the one or more processors to adjust, based on use of the encoder output data, the retention priority of the encoder output data.

Example 48 includes the non-transitory computer-readable medium of any of Examples 45 to 47, wherein the instructions, when executed by one or more processors, cause the one or more processors to perform the image-based cognitive analysis.

Example 49 includes the non-transitory computer-readable medium of any of Examples 45 to 48, wherein the instructions, when executed by one or more processors, cause the one or more processors to generate image tokens based on the encoder output data; generate linguistic tokens based on a query; and use a multimodal transformer network to perform the image-based cognitive analysis based on the image tokens and the linguistic tokens to generate a response.

Example 50 includes the non-transitory computer-readable medium of any of Examples 45 to 49, wherein the instructions, when executed by one or more processors, cause the one or more processors to receive, using a modem, the sequence of image frames.

Example 51 includes the non-transitory computer-readable medium of any of Examples 45 to 50, wherein the instructions, when executed by one or more processors, cause the one or more processors to generate, using a camera, the sequence of image frames.

According to Example 52, a non-transitory computer-readable medium stores instructions that, when executed by one or more processors, cause the one or more processors to receive, from a vision encoder of a device, encoder output data for image-based cognitive analysis, the encoder output data representing an image frame of a sequence of image frames; and based on a retention policy and a retention priority of the encoder output data, selectively send a deletion command to the device to remove the encoder output data from image analysis data stored at the device.

Example 53 includes the non-transitory computer-readable medium of Example 52, wherein the instructions, when executed by one or more processors, cause the one or more processors to, based on a user input, update the retention priority of the encoder output data.

Example 54 includes the non-transitory computer-readable medium of Example 52 or Example 53, wherein the instructions, when executed by one or more processors, cause the one or more processors to adjust, based on use of the encoder output data, the retention priority of the encoder output data.

Example 55 includes the non-transitory computer-readable medium of any of Examples 52 to 54, wherein the instructions, when executed by one or more processors, cause the one or more processors to perform the image-based cognitive analysis.

Example 56 includes the non-transitory computer-readable medium of any of Examples 52 to 55, wherein the instructions, when executed by one or more processors, cause the one or more processors to generate image tokens based on the encoder output data; generate linguistic tokens based on a query; and use a multimodal transformer network to perform the image-based cognitive analysis based on the image tokens and the linguistic tokens to generate a response.

Example 57 includes the non-transitory computer-readable medium of any of Examples 52 to 56, wherein the instructions, when executed by one or more processors, cause the one or more processors to receive, using a modem, the encoder output data from the device.

Example 58 includes the non-transitory computer-readable medium of any of Examples 52 to 57, wherein the instructions, when executed by one or more processors, cause the one or more processors to send, using a modem, the deletion command to the device.

According to Example 59, a non-transitory computer-readable medium stores instructions that, when executed by one or more processors, cause the one or more processors to receive encoder output data from a vision encoder of a device, the encoder output data representing an image frame of a sequence of image frames; add the encoder output data to image analysis data used to represent the sequence of image frames for image-based cognitive analysis; and based on a retention policy and a retention priority of the encoder output data, determine whether to remove the encoder output data from the image analysis data.

Example 60 includes the non-transitory computer-readable medium of Example 59, wherein the instructions, when executed by one or more processors, cause the one or more processors to, based on a user input, update the retention priority of the encoder output data.

Example 61 includes the non-transitory computer-readable medium of Example 59 or Example 60, wherein the instructions, when executed by one or more processors, cause the one or more processors to adjust, based on use of the encoder output data, the retention priority of the encoder output data.

Example 62 includes the non-transitory computer-readable medium of any of Examples 59 to 61, wherein the instructions, when executed by one or more processors, cause the one or more processors to perform the image-based cognitive analysis.

Example 63 includes the non-transitory computer-readable medium of any of Examples 59 to 62, wherein the instructions, when executed by one or more processors, cause the one or more processors to generate image tokens based on the encoder output data; generate linguistic tokens based on a query; and use a multimodal transformer network to perform the image-based cognitive analysis based on the image tokens and the linguistic tokens to generate a response.

Example 64 includes the non-transitory computer-readable medium of any of Examples 59 to 63, wherein the instructions, when executed by one or more processors, cause the one or more processors to receive, using a modem, the encoder output data.

According to Example 65, an apparatus includes means for using a vision encoder to process an image frame of a sequence of image frames to generate encoder output data; means for adding the encoder output data to image analysis data used to represent the sequence of image frames for image-based cognitive analysis; and means for determining, based on a retention policy and a retention priority of the encoder output data, whether to remove the encoder output data from the image analysis data.

Example 66 includes the apparatus of Example 65, further comprising means for updating, based on a user input, the retention priority of the encoder output data.

Example 67 includes the apparatus of Example 65 or Example 66, further comprising means for adjusting, based on use of the encoder output data, the retention priority of the encoder output data.

Example 68 includes the apparatus of any of Examples 65 to 67 and further includes means for performing the image-based cognitive analysis.

Example 69 includes the apparatus of any of Examples 65 to 68, further includes means for generating image tokens based on the encoder output data; means for generating linguistic tokens based on a query; and means for using a multimodal transformer network to perform the image-based cognitive analysis based on the image tokens and the linguistic tokens to generate a response.

Example 70 includes the apparatus of any of Examples 65 to 69, wherein at least one of the means for using, the means for adding, or the means for determining is integrated into a headset, a communication device, or both.

Example 71 includes the apparatus of any of Examples 65 to 70 and further includes means for receiving the sequence of image frames.

Example 72 includes the apparatus of any of Examples 65 to 71 and further includes means for generating the sequence of image frames.

According to Example 73, an apparatus includes means for receiving, from a vision encoder of a device, encoder output data for image-based cognitive analysis, the encoder output data representing an image frame of a sequence of image frames; and means for selectively sending, based on a retention policy and a retention priority of the encoder output data, a deletion command to the device to remove the encoder output data from image analysis data stored at the device.

Example 74 includes the apparatus of Example 73, further comprising means for updating, based on a user input, the retention priority of the encoder output data.

Example 75 includes the apparatus of Example 73 or Example 74, further comprising means for adjusting, based on use of the encoder output data, the retention priority of the encoder output data.

Example 76 includes the apparatus of any of Examples 73 to 75 and further includes means for performing the image-based cognitive analysis.

Example 77 includes the apparatus of any of Examples 73 to 76, further includes means for generating image tokens based on the encoder output data; means for generating linguistic tokens based on a query; and means for using a multimodal transformer network to perform the image-based cognitive analysis based on the image tokens and the linguistic tokens to generate a response.

Example 78 includes the apparatus of any of Examples 73 to 77, wherein at least one of the means for receiving or the means for selectively sending is integrated into a headset, a communication device, or both.

According to Example 79, an apparatus includes means for receiving encoder output data from a vision encoder of a device, the encoder output data representing an image frame of a sequence of image frames; means for adding the encoder output data to image analysis data used to represent the sequence of image frames for image-based cognitive analysis; and means for determining, based on a retention policy and a retention priority of the encoder output data, whether to remove the encoder output data from the image analysis data.

Example 80 includes the apparatus of Example 79, further comprising means for updating, based on a user input, the retention priority of the encoder output data.

Example 81 includes the apparatus of Example 79 or Example 80, further comprising means for adjusting, based on use of the encoder output data, the retention priority of the encoder output data.

Example 82 includes the apparatus of any of Examples 79 to 81 and further includes means for performing the image-based cognitive analysis.

Example 83 includes the apparatus of any of Examples 79 to 82, further includes means for generating image tokens based on the encoder output data; means for generating linguistic tokens based on a query; and means for using a multimodal transformer network to perform the image-based cognitive analysis based on the image tokens and the linguistic tokens to generate a response.

Example 84 includes the apparatus of any of Examples 79 to 83, wherein at least one of the means for receiving, the means for adding, or the means for determining are integrated into a headset, a communication device, or both.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
a memory configured to store image analysis data; and
one or more processors coupled to the memory and configured to:
use a vision encoder to process an image frame of a sequence of image frames to generate encoder output data;
add the encoder output data to the image analysis data used to represent the sequence of image frames for image-based cognitive analysis; and
based on a retention policy and a retention priority of the encoder output data, determine whether to remove the encoder output data from the image analysis data.

2. The device of claim 1, wherein the one or more processors are configured to, based on a user input, update the retention priority of the encoder output data.

3. The device of claim 1, wherein the one or more processors are configured to adjust, based on use of the encoder output data, the retention priority of the encoder output data.

4. The device of claim 1, wherein the one or more processors are configured to perform the image-based cognitive analysis.

5. The device of claim 1, wherein the one or more processors are configured to:
generate image tokens based on the encoder output data;
generate linguistic tokens based on a query; and
use a multimodal transformer network to perform the image-based cognitive analysis based on the image tokens and the linguistic tokens to generate a response.

6. The device of claim 1, wherein the one or more processors and the memory are integrated into a headset, a communication device, or both.

7. The device of claim 1, further comprising a modem coupled to the one or more processors and configured to receive the sequence of image frames.

8. The device of claim 1, further comprising a camera coupled to the one or more processors and configured to generate the sequence of image frames.

9. A device comprising:
a memory configured to store sets of encoder output data; and
one or more processors coupled to the memory and configured to:
receive, from a vision encoder of a second device, encoder output data for image-based cognitive analysis, the encoder output data representing an image frame of a sequence of image frames; and
based on a retention policy and a retention priority of the encoder output data, selectively send a deletion command to the second device to remove the encoder output data from image analysis data stored at the second device.

10. The device of claim 9, wherein the one or more processors are configured to, based on a user input, update the retention priority of the encoder output data.

11. The device of claim 9, wherein the one or more processors are configured to adjust, based on use of the encoder output data, the retention priority of the encoder output data.

12. The device of claim 9, wherein the one or more processors are configured to perform the image-based cognitive analysis.

13. The device of claim 9, wherein the one or more processors are configured to:
generate image tokens based on the encoder output data;
generate linguistic tokens based on a query; and
use a multimodal transformer network to perform the image-based cognitive analysis based on the image tokens and the linguistic tokens to generate a response.

14. The device of claim 9, wherein the one or more processors and the memory are integrated into a headset, a communication device, or both.

15. The device of claim 9, further comprising a modem coupled to the one or more processors and configured to receive the encoder output data from the second device.

16. The device of claim 9, further comprising a modem coupled to the one or more processors and configured to send the deletion command to the second device.

17. A device comprising:
a memory configured to store image analysis data; and
one or more processors coupled to the memory and configured to:
receive encoder output data from a vision encoder of a second device, the encoder output data representing an image frame of a sequence of image frames;
add the encoder output data to the image analysis data used to represent the sequence of image frames for image-based cognitive analysis; and
based on a retention policy and a retention priority of the encoder output data, determine whether to remove the encoder output data from the image analysis data.

18. The device of claim 17, wherein the one or more processors are configured to, based on a user input, update the retention priority of the encoder output data.

19. The device of claim 17, wherein the one or more processors are configured to adjust, based on use of the encoder output data, the retention priority of the encoder output data.

20. The device of claim 17, wherein the one or more processors are configured to perform the image-based cognitive analysis.

21. The device of claim 17, wherein the one or more processors are configured to:
generate image tokens based on the encoder output data;
generate linguistic tokens based on a query; and
use a multimodal transformer network to perform the image-based cognitive analysis based on the image tokens and the linguistic tokens to generate a response.

22. The device of claim 17, wherein the one or more processors and the memory are integrated into a headset, a communication device, or both.

23. The device of claim 17, further comprising a modem coupled to the one or more processors and configured to receive the encoder output data.

24. A method comprising:
using a vision encoder to process an image frame of a sequence of image frames to generate encoder output data;
adding the encoder output data to image analysis data used to represent the sequence of image frames for image-based cognitive analysis; and
based on a retention policy and a retention priority of the encoder output data, determining whether to remove the encoder output data from the image analysis data.

25. The method of claim 24, further comprising, based on a user input, updating the retention priority of the encoder output data.

26. The method of claim 24, further comprising adjusting, based on use of the encoder output data, the retention priority of the encoder output data.

27. The method of claim 24, further comprising performing the image-based cognitive analysis.

28. The method of claim 24, further comprising:
generating image tokens based on the encoder output data;
generating linguistic tokens based on a query; and
using a multimodal transformer network to perform the image-based cognitive analysis based on the image tokens and the linguistic tokens to generate a response.

29. The method of claim 24, wherein the vision encoder is integrated into a headset, a communication device, or both.

30. The method of claim 24, further comprising receiving, using a modem, the sequence of image frames.
